(19) United States
(12) Patent Application Publication
(10) Pub. No.: US 2019/0390449 A1
(43) Pub. Date: Dec. 26, 2019

(54) WASHBOWL

(71) Applicant: LIXIL Corporation, Tokyo (JP)

(72) Inventors: Hiroshi KOBAYASHI, Tokyo (JP); Toshinori MORI, Tokyo (JP); Kazuo TAKEUCHI, Tokyo (JP); Shunzou IWASAKI, Tokyo (JP); Isao YOSHINAGA, Tokyo (JP); Hiroyuki MIYAMOTO, Tokyo (JP); Tadashi ASHIZAWA, Tokyo (JP); Hideaki SAWADA, Tokyo (JP); Jaehoon CHOI, Tokyo (JP); Shuji KAWAI, Tokyo (JP)

(73) Assignee: LIXIL Corporation, Tokyo (JP)

(21) Appl. No.: 16/443,611

(22) Filed: Jun. 17, 2019

(30) Foreign Application Priority Data
Jun. 20, 2018 (JP) 2018-117448

(51) Int. Cl. E03C 1/14; C04B 41/86

(52) U.S. Cl. CPC E03C 1/14; C04B 41/86

(57) ABSTRACT

The washbowl includes a bowl recessed downward, and comprising a ceramics base material, an intermediate layer disposed on a surface side of the ceramics base, and an upper glaze layer disposed on a surface side of the intermediate layer, the upper glaze layer being more transparent than the intermediate layer; and a drainage port. The bowl includes an inclined surface formed on a surface of the bowl and continuously recessed downward, the inclined surface formed at a position at least on a front side of the surface of the bowl when a user uses the bowl, the position being configured to be seen by the user, and the inclined surface is formed such that a tangent to the inclined surface is formed at 5 degrees to 75 degrees with respect to a horizontal plane.

### CROSS REFERENCE TO RELATED APPLICATIONS

This application claims the priority of Japanese Application No. 2018-117448 filed on Jun. 20, 2018, the entire contents of which are incorporated herein by reference.

### FIELD OF THE INVENTION

This disclosure relates to a washbowl.

### BACKGROUND OF THE INVENTION

Conventionally, in a washbowl installed in a washroom, an upper glaze layer (a glaze layer) is formed on an outermost surface of the washbowl in order to inhibit adhesion of dirt and to improve the design characteristics of the appearance.

For example, Japanese Patent Application Publication No. 2005-298250 proposes sanitary ware in which a first colored glaze layer is formed on a surface of a ceramics base material and a second transparent glaze layer is formed onto the first glaze layer. This sanitary ware brings an improvement of surface smoothness and an improvement of thermal shock resistance.

### SUMMARY OF THE INVENTION

In recent years, washbowls have been required to have high grade along with improvement of design and the like. One of the indicators indicating grade is image clarity Image clarity is an indicator that expresses the sharpness of an image reflected in a surface of sanitary ware, and the image clarity is determined to be higher as the reflected image becomes clearer.

In addition to the image clarity, “depth” is an exemplary example of an indicator indicating the grade. An upper glaze layer is formed on a surface of sanitary ware. The “depth” is an expression of a thickness (depth) of the upper glaze layer. The depth is recognized by human vision. Since whole of beauty of the upper glaze layer is not able to be felt with image clarity alone, a washbowl in which “depth” is capable of being sensed is desired.

The washbowl according to the present disclosure is a washbowl including a bowl recessed downward, and comprising a ceramics base material, an intermediate layer disposed on a surface side of the ceramics base, and an upper glaze layer disposed on a surface side of the intermediate layer, the upper glaze layer being more transparent than the intermediate layer; and a drainage port, wherein the bowl includes an inclined surface formed on a surface of the bowl and continuously recessed downward, the inclined surface formed at a position at least on a front side of the surface of the bowl when a user uses the bowl, the position being configured to be seen by the user, and the inclined surface is formed such that a tangent to the inclined surface is 5 degrees to 75 degrees with respect to a horizontal plane.

### BRIEF DESCRIPTION OF THE DRAWINGS

The invention will now be described, by way of example only, with reference to the accompanying drawings, in which:

FIG. 1 is a cross-section view of a space in which a washbowl is installed, according to some embodiments;

FIG. 2 is a plan view of the washbowl, according to some embodiments;

FIG. 3 is a cross-sectional view taken along a line A-A in FIG. 2, according to some embodiments;

FIG. 4 is a diagram showing a cross-sectional structure of the washbowl, according to some embodiments;

FIG. 5 is an example of a differential thermal analysis (DTA) curve of an upper glaze layer of the washbowl, according to some embodiments;

FIG. 6 is a graph showing a Fresnel reflectance, according to some embodiments;

FIG. 7 is a side view of a space in which the washbowl according to a first modified example is installed, according to some embodiments;

FIG. 8 is a plan view of a washbowl according to the first modified example, according to some embodiments;

FIG. 9 is a cross-sectional view taken along a line B-B in FIG. 8, according to some embodiments;

FIG. 10 is a cross-sectional view of a washbowl according to the second modified example, according to some embodiments; and

FIG. 11 is a cross-sectional view of a washbowl according to the third modified example, according to some embodiments.

### DETAILED DESCRIPTION OF THE INVENTION

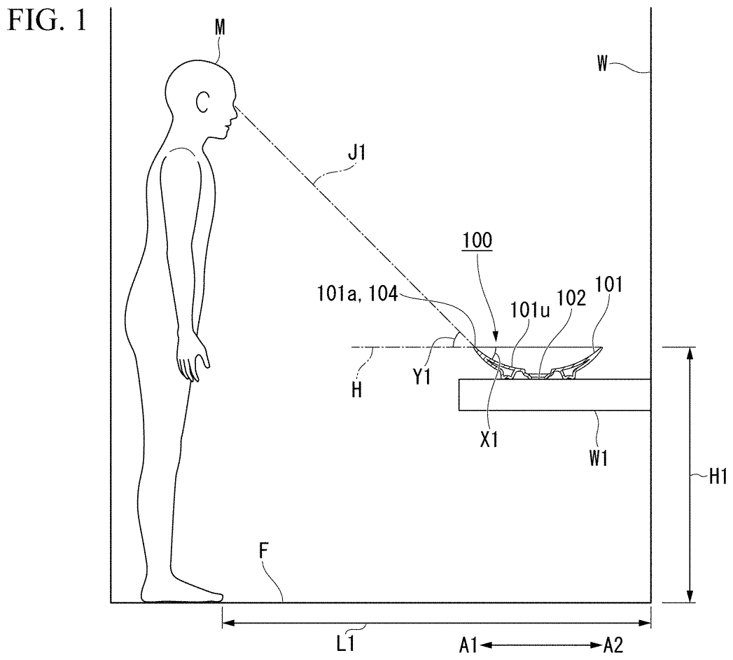

As shown in FIG. 1, the washbowl 100 of the embodiment is installed along a wall W of a washroom and the like. The washbowl 100 is installed on an installation table W1 supported by the wall W. A water discharge port, piping, or the like (not shown) are provided in the wall W.

The washbowl 100 is a member obtained by forming sanitary ware 1 as a material into a desired shape. First, a shape of the washbowl 100 will be described. In the following description, when a user M uses the washbowl 100, the user M side (A1 side) in the washbowl 100 is referred to as a front side, and the opposite side of the front side (A2 side) is referred to as a back side. The washbowl 100 has a bowl portion 101 in which a recessed portion recessed downward is formed.

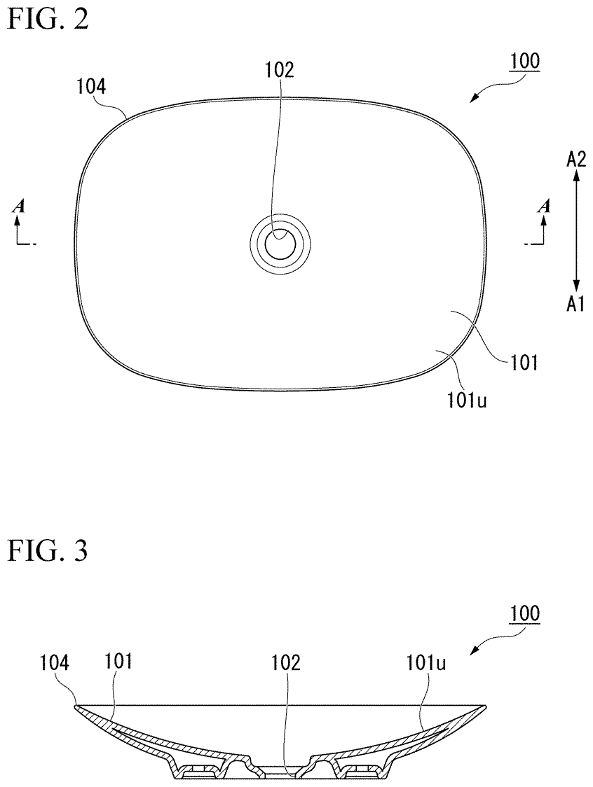

FIG. 2 is a plan view of the washbowl 100. As shown in FIG. 2, the washbowl 100 has a substantially rectangular shape in a plan view. The washbowl 100 is formed such that four corners of the washbowl 100 have a curved shape.

A drainage port 102 is provided substantially in a center of the bowl portion 101 in a plan view. Water discharged from a water discharge port (not shown) provided on the wall W or the like passes through the drainage port 102 and is drained to a water drain pipe (not shown).

As shown in FIGS. 1 and 3, a surface of the bowl portion 101 is formed by a continuous curved surface (an inclined surface) 101u recessed downward. In the disclosure, “a surface of the bowl portion” means an upper surface of the bowl portion. The upper surface of the bowl portion is positioned at a side to be stored a water in the bowl portion, and the upper surface contacts a stored water when a water stores in the bowl portion. In detail, the surface of the bowl portion 101 is formed into the curved surface 101u except for the drainage port 102 and the vicinity of the drainage port 102. The curved surface 101u is inclined downward from a circumferential edge portion 104 of the bowl portion 101 toward the center side thereof in a plan view.

As shown in FIG. 1, an end portion 101a forms the circumferential edge portion 104 of the bowl portion 101. The end portion 101a is an end part on the front side of the curved surface 101u. That is, a wall portion standing upward from the end portion 101a, a wall portion extending to the front side, or the like are not provided at the end portion 101a.

The front side of the curved surface 101u gradually inclines downward toward the back side (A2 side).

An angle (an edge angle) X1 formed between a tangent to the end portion 101a and the horizontal plane H may be about 5 degrees or more. The angle X1 may be 35 degrees or more. The angle X1 may be about 75 degrees or less. The angle X1 may be 45 degrees or less. It is not only limited a case that the edge angle X1 is about 5 to 75 degrees but also a case that an angle of the tangent to a place, where is on the back side behind the end portion 101 in the curved surface 101u, that is, on the front side of the curved surface 101u which the user M can visually recognize, with respect to the horizontal plane may be formed at 5 degrees to 75 degrees. In the embodiment, the angle X1 is about 45 degrees.

In the case of a house with a Japanese standard scale module, an inside dimension L1 of a tsubo space is approximately 1,690 mm (“a tsubo space” is a unit of area in traditional Japanese system of weights and measures, and is approximately 3.3057 m2), it is common to place the washbowl 100 above a floor surface F at a height H1 of approximately 800 mm Assuming that a height of the user M is about 170 cm, when the user M stands by the wall side, an angle Y1 between a line of sight J1 directed from the user M toward the end portion 101a of the washbowl 100 and the horizontal plane H is substantially the same as the angle X1. Accordingly, the line of sight J1 of the user M follows the curved surface 101u from the end portion 101a of the bowl portion 101.

[Sanitary Ware]

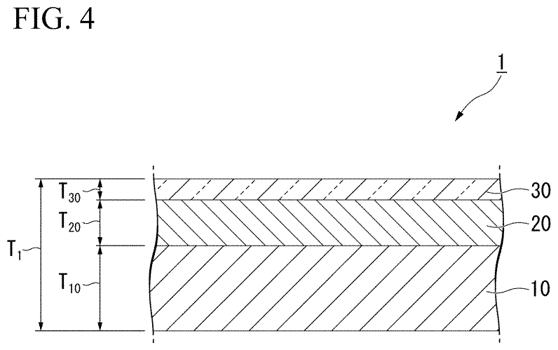

Next, the sanitary ware 1 will be described. As shown in FIG. 4, the sanitary ware 1 includes a ceramics base material 10, an intermediate layer 20 disposed on a surface side of the ceramics base material 10, and an upper glaze layer 30 disposed on a surface side of the intermediate layer 20.

A thickness T1 of the sanitary ware 1 is not particularly limited. For example, a lower limit value of the thickness T1 may be 1 mm. The lower limit value of the thickness T1 may be 2 mm. The lower limit value of the thickness T1 may be 3 mm. For example, a maximum limit value of the thickness T1 may be 50 mm. The maximum limit value of the thickness T1 may be 30 mm. The maximum limit value of the thickness T1 is 20 mm. When the thickness T1 is equal to or thicker than the above-mentioned lower limit value, the strength of the sanitary ware 1 is likely to be enhanced. When the thickness T1 is equal to or thinner than the above-mentioned upper limit value (50 mm or less), the sanitary ware 1 can be made lightweight so that it becomes easy to handle. The thickness T1 of the sanitary ware 1 can be measured, for example, using a vernier caliper.

A lower limit value of image clarity of the sanitary ware 1 may be 80 or more. The lower limit value of the image clarity of the sanitary ware 1 may be 85 or more. The lower limit value of the image clarity of the sanitary ware 1 may be 90 or more. When the image clarity of the sanitary ware 1 is equal to or more than the lower limit value (80 or more), it is easy to give an impression of high grade. The upper limit value of the image clarity of the sanitary ware 1 is not particularly limited, but is substantially 99 or less. In the present specification, the image clarity means a distinctness of image (DOI) value measured by a Wave-Scan DOI measuring device (Wave-Scan-DUAL, manufactured by BYK Gardner).

[Ceramic Base Material]

As an example of the ceramics base material 10, a base material made by forming a ceramics base material composition (ceramics base material sludge) containing feldspar, pottery stone, kaolin, clay and the like as raw materials into a predetermined shape using a plaster mold or a resin mold, and firing at 1,100 to 1,300° C. (degrees Celsius) may be used. The ceramics base material composition contains water. The lower limit value of the amount of water relative to a total mass of the ceramics base material composition may be 30% by mass. The upper limit value of the amount of water relative to the total mass of the ceramics base material composition may be 50% by mass. The upper limit value of the amount of water relative to the total mass of the ceramics base material composition may be 40% by mass.

A thickness T10 of the ceramics base material 10 is not particularly limited. For example, the lower limit value of the thickness T10 of the ceramics base material 10 may be 1 mm. The lower limit value of the thickness T10 may be 2 mm. The lower limit value of the thickness T10 may be 3 mm. The upper limit value of the thickness T10 may be 50 mm. The upper limit value of the thickness T10 may be 30 mm. The upper limit value of the thickness T10 may be 20 mm. When the thickness T10 is equal to or thicker than the above-mentioned lower limit value (1 mm or more), the strength of the ceramics base material 10 is likely to be enhanced. When the thickness T10 is equal to or less than the above-mentioned upper limit value (50 mm or less), the ceramics base material 10 is capable of being made lightweight so that it becomes easy to handle. The thickness T10 of the ceramics base material 10 can be measured, for example, using a vernier caliper.

[Upper Glaze Layer]

The upper glaze layer 30 is a fired product of an upper glaze layer composition for sanitary ware (hereinafter, also simply referred to as an upper glaze layer composition). The upper glaze layer 30 is a layer made of glaze (a glazing agent) for forming a layer positioned on an outermost surface of the sanitary ware 1. The upper glaze layer composition is a so-called glaze. The upper glaze layer composition is slurry (sludge) in which glaze raw materials are dispersed in water. The graze raw materials includes silica sand, feldspar, lime, clay, and so on. The amount of water relative to a total mass of the upper glaze layer composition may be 40 to 80% by mass. The amount of water relative to a total mass of the upper glaze layer composition may be 40 to 70% by mass.

The average particle size of a solid content contained in the upper glaze layer composition may be 20 μm or less. The average particle size of a solid content contained in the upper glaze layer composition may be 15 μm or less. The average particle size of a solid content contained in the upper glaze layer composition may be 10 μm or less. When the average particle size of the solid content contained in the upper glaze layer composition is equal to or less than the above upper limit value (20 μm or less), it is easy to lower a melting start temperature of the solid content contained in the upper glaze layer composition. The lower limit value of the average particle size of the solid content contained in the upper glaze layer composition is not particularly limited. The lower limit value of the average particle size of the solid content contained in the upper glaze layer composition is, for example, 0.1 μm or more. The average particle size of the solid content contained in the upper glaze layer composition can be adjusted, for example, by grinding the glaze raw materials. An example of tools for grinding the glaze raw materials is a ball mill.

In the present specification, the “average particle size” means a 50% average particle size (D50). D50 is a median diameter on a number basis, and means an average particle size at 50% in a cumulative distribution. The particle size can be measured, for example, using a laser diffraction type particle size distribution measuring device (manufactured by Nikkiso Co., Ltd., model number “MT3300EX”). The solid content contained in the upper glaze layer composition is dried materials of the upper glaze layer composition.

As an example of the upper glaze layer composition, a composition containing 5 to 25 parts by mass of silica sand, 20 to 40 parts by mass of feldspar, 5 to 15 parts by mass of lime, and 1 to 5 parts by mass of clay may be used. The upper glaze layer composition may contain a frit in addition to the above. The frit is obtained by melting a frit raw material at 1,300° C. or higher and then cooling to produce an amorphous glass. As a result that the upper glaze layer composition contains the frit, the melting start temperature of the upper glaze layer composition is easily lowered. In addition, the upper glaze layer composition contains the frit so that the upper glaze layer composition is easily melted to be more uniform and thereby the number of pores in the upper glaze layer is easily reduced. As an example of the frit raw material, a composition which contains 40 to 70% by mass of silicon dioxide (SiO2), 5 to 15% by mass of aluminum oxide (Al2O3), and 10 to 50% by mass of a total of sodium oxide (Na2O), potassium oxide (K2O), calcium oxide (CaO), magnesium oxide (MgO), zinc oxide (ZnO), strontium oxide (SrO), barium oxide (BaO) and boron oxide (B2O3), with respect to the total mass of frit material, may be used. The total amount of each component in the frit raw material is adjusted such that it does not exceed 100% by mass with respect to the total mass of the frit raw material.

When the upper glaze layer composition contains the frit, the amount of the frit may be 50 to 100% by mass with respect to the total mass of the solid content contained in the upper glaze layer composition. The amount of the frit thereof may be 70 to 100% by mass. When the amount of the frit is equal to or more than the above lower limit value (50% by mass or more), the melting start temperature of the upper glaze layer composition is easily lowered. The amount of the frit is adjusted not to exceed 100% by mass with respect to the total mass of the solid content contained in upper glaze layer composition.

The melting start temperature of the upper glaze layer composition can be defined by any of the first melting temperature, the second melting temperature, and the third melting temperature. The first melting temperature is measured by the following measurement method 1-1.

<Measurement Method 1-1>

A differential thermal analysis (DTA) measurement is performed using a sample powder which is alumina powder as a reference substance and the dried materials of the upper glaze layer composition for sanitary ware, and a DTA curve is obtained. In a region above 700° C. of the obtained DTA curve, a temperature of the reference substance at the earliest inflection point where a potential difference ΔV decreases is taken as the first melting temperature. The potential difference ΔV corresponds to a value ΔT obtained by subtracting a temperature of the reference substance from a temperature of the sample powder. The temperature of the reference substance at the earliest inflection point where the potential difference ΔV increases in a temperature region higher than the first melting temperature is taken as the second melting temperature.

The DTA curve is obtained by performing the DTA measurement using a differential thermal analysis (DTA) device. The DTA measurement may be a TG-DTA measurement (a thermogravimetric differential thermal analysis measurement). In the DTA measurement, alumina powder is used as the reference substance, and the dried materials of the upper glaze layer composition is used as the sample powder. The dried materials of the upper glaze layer composition are obtained, for example, by heating the upper glaze layer composition to 20 to 110° C. to evaporate the water. The lower limit value of the amount of water with respect to the total mass of the dried materials of the upper glaze layer composition is, for example, 0% by mass. The upper limit value of the amount of water with respect to the total mass of the dried materials of the upper glaze layer composition is, for example, 1% by mass. In the DTA measurement, the potential difference ΔV is measured as a function of temperature while changing the temperature of the sample powder and the temperature of the reference substance using a specific program. The potential difference ΔV is correspond to the value ΔT which obtained by subtracting the temperature of the reference substance from the temperature of the sample powder, that is, (the temperature of the sample powder)−(the temperature of the reference substance). In the DTA curve, among inflection points appearing in a region where the temperature of the reference substance exceeds 700° C., the earliest inflection point where the potential difference ΔV decreases is taken as the first inflection point. The temperature of the reference substance at the first inflection point is taken as the first melting temperature. Among inflection points appearing in a temperature region higher than the first melting temperature, the earliest inflection point where the potential difference ΔV increases is taken as the second inflection point. The temperature of the reference substance at the second inflection point is taken as the second melting temperature.

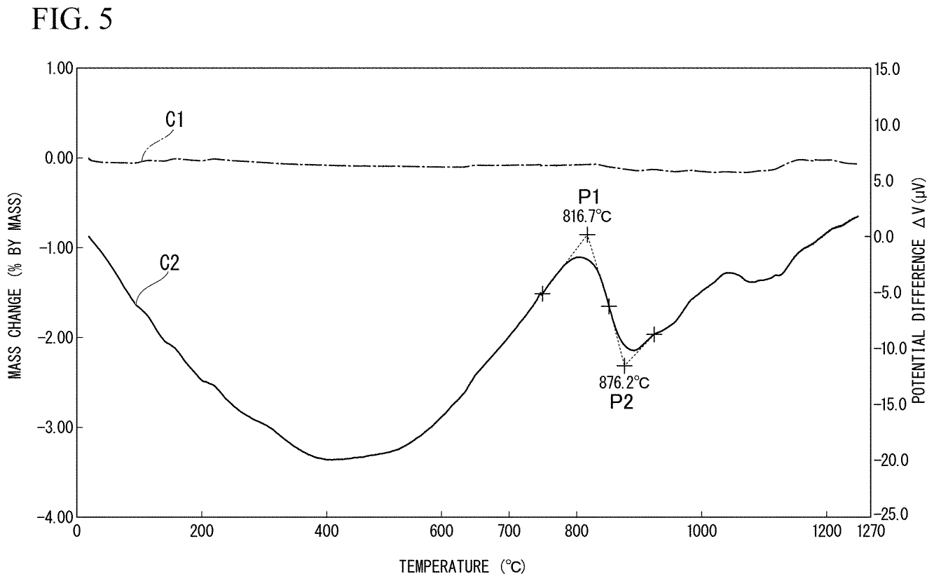

FIG. 5 is a TG-DTA graph obtained when the TG-DTA measurement of the upper glaze layer composition forming the upper glaze layer 30 of the sanitary ware 1 is performed. In the TG-DTA graph, the horizontal axis represents the temperature (° C.) of the reference substance. The first axis of the vertical axis represents a mass change (% by mass) of the sample powder. The second axis of the vertical axis represents the potential difference ΔV (μV) indicating the value ΔT obtained by subtracting the temperature of the reference substance from the temperature of the sample powder. In FIG. 5, a line C1 represents a TG curve. A Line C2 represents a DTA curve. In C2, the potential difference ΔV increases as the temperature of the reference substance increases, and the first inflection point P1 appears in the region where the temperature of the reference substance exceeds 700° C. At the first inflection point P1, it is considered that the upper glaze layer composition starts melting and a glass structure of the upper glaze layer composition starts to loosen. The first inflection point P1 is obtained by intersection point between a tangent drawn to the line C2 when the slope of the line C2 (an amount of increase of ΔV/an amount of increase of the temperature of the reference substance) is a maximum and a tangent drawn to the line C2 when the slope of the line C2 is a minimum. The temperature of the reference substance at the first inflection point P1 is the first melting temperature. The first melting temperature is determined in the same manner as in a method of determining an extrapolation melting start temperature in a general TG-DTA graph (see JIS K7121-1987). In the line C2, and the line C2 has the second inflection point P2 in which ΔV decreases after the first inflection point P1 appears and ΔV increases again. At the second inflection point P2, it is considered that the upper glaze layer composition is melted and the glass structure of the upper glaze layer composition is completely loosened. The second inflection point P2 is obtained by an intersection point between a tangent drawn to the line C2 when the slope of the line C2 is a minimum and a tangent drawn to the line C2 when the slope of the line C2 becomes positive. The temperature of the reference substance at the second inflection point P2 is the second melting temperature. The second melting temperature is determined in the same manner as in a method of determining a melting peak temperature in a general TG-DTA graph (see JIS K7121-1987).

In the DTA measurement, the lower limit value of a mass of the reference substance may be 5 mg, for example. The upper limit value of the mass of reference substance in the DTA measurement may be 50 mg, for example. The lower limit value of a mass of the sample powder may be 5 mg, for example. The upper limit value of the mass of the sample powder may be 50 mg, for example. The lower limit value of the heating temperature for obtaining the dried materials of the upper glaze layer composition may be 200° C. for example. The upper limit value of the heating temperature for obtaining the dried materials of the upper glaze layer composition may be, 110° C., for example. The lower limit value of the heating rate at the time of heating the sample powder may be 2° C./minute, for example. The upper limit value of the heating rate at the time of heating the sample powder may be 10° C./minute, for example.

The lower limit value of the first melting temperature of the upper glaze layer composition may be 800° C. The upper limit value of the first melting temperature of the upper glaze layer composition may be 1,050° C. The lower limit value of the first melting temperature of the upper glaze layer composition may be 820° C. The lower limit value of the first melting temperature of the upper glaze layer composition may be 840° C. The upper limit value of the first melting temperature of the upper glaze layer composition may be 1,000° C. The upper limit value of the first melting temperature of the upper glaze layer composition may be 950° C. When the first melting temperature of the upper glaze layer composition is equal to or higher than the above lower limit value (800° C. or higher), generation of bubbles when firing the upper glaze layer composition is easily inhibited. When the first melting temperature of the upper glaze layer composition is equal to or less than the upper limit value (1,000° C. or less), the bubbles generated when firing the upper glaze layer composition easily diffuse into the atmosphere.

The second melting temperature is measured by the above measurement method 1-1. The lower limit value of the second melting temperature of the upper glaze layer composition may be 850° C. The upper limit value of the second melting temperature of the upper glaze layer composition may be 1,150° C. The lower limit value of the second melting temperature of the upper glaze layer composition may be 870° C. The lower limit value of the second melting temperature of the upper glaze layer composition may be 900° C. The upper limit value of the second melting temperature of the upper glaze layer composition may be 1,100° C. The upper limit value of the second melting temperature of the upper glaze layer composition may be 1,050° C. When the second melting temperature of the upper glaze layer composition is equal to or higher than the above lower limit value (850° C. or more), generation of bubbles when firing the upper glaze layer composition is easily inhibited. When the second melting temperature of the upper glaze layer composition is equal to or less than the above upper limit value (1,150° C. or less), the bubbles generated when firing the upper glaze layer composition are easily diffused into the atmosphere.

A lower limit value of the difference between the second melting temperature and the first melting temperature of the upper glaze layer composition (an upper glaze layer melting temperature difference) may be 50° C. The upper limit value of the upper glaze layer melting temperature difference may be 120° C. The lower limit value of the upper glaze layer melting temperature difference may be 60° C. The lower limit value of the upper glaze layer melting temperature difference may be 70° C. The upper limit value of the upper glaze layer melting temperature difference may be 100° C. The upper limit value of the upper glaze layer melting temperature difference may be 90° C. When the upper glaze layer melting temperature difference is equal to or more than the above lower limit value (50° C. or more), an average pore size of pores generated when the upper glaze layer composition is fired is easily reduced. When the upper glaze layer melting temperature difference is equal to or less than the above upper limit value (120° C. or less), generation of pores when firing the upper glaze layer composition is easily inhibited. The upper glaze layer melting temperature difference is determined by subtracting the first melting temperature of the upper glaze layer composition from the second melting temperature of the upper glaze layer composition.

The first melting temperature of the upper glaze layer composition can be adjusted on the basis of a type of the glaze raw material, a blending proportion of the glaze raw material, the average particle size of the solid amount of the upper glaze layer composition, and a combination thereof. The second melting temperature of the upper glaze layer composition can be adjusted similarly to the first melting temperature of the upper glaze layer composition.

The third melting temperature is measured by the following measurement method 1-2.

<Measurement Method 1-2>

The dried materials of the upper glaze layer composition for sanitary ware are press-molded and obtains a cylindrical sample. Light is radiated while heating the obtained cylindrical sample. A light amount of the reflected light reflected by a surface of the cylindrical sample is measured. The earliest temperature where the light amount of the reflected light becomes ten times or more the light amount of the reflected light detected at the beginning of glistening is taken as the third melting temperature.

In the measurement method 1-2, the cylindrical sample is obtained by press-molding the dried materials of the upper glaze layer composition for sanitary ware. The lower limit value of the diameter of the cylindrical sample may be 2 mm, for example. The upper limit value of the diameter of the cylindrical sample may be 10 mm, for example. The lower limit value of the height of the cylindrical sample may be 5 mm, for example. The upper limit value of the height of the cylindrical sample may be 20 mm, for example. The lower limit value of the mass of the cylindrical sample may be 100 mg, for example. The upper limit value of the mass of the cylindrical sample may be 500 mg, for example. The lower limit value of the pressure for press-molding the dried materials of the upper glaze layer composition may be 10 Mpa, for example. The upper limit value of the pressure for press-molding the dried materials of the upper glaze layer composition may be 50 MPa, for example. The light amount of the reflected light is a value obtained such that the reflected light is taken by a digital camera with a telephoto lens and is converted to a number of pixels by an image processing system. The light amount of the reflected light when heating the cylindrical sample is measured every 1° C. The “beginning of glistening” means that the light amount of the reflected light reflected by the surface of the cylindrical sample is not zero. The lower limit value of the heating rate at the time of heating the cylindrical sample may be 1° C./minute, for example. The upper limit value of the heating rate at the time of heating the cylindrical sample may be 10° C./minute. The lower limit value of the light amount of the light radiated to the cylindrical sample may be 500 lumens, for example. The upper limit value of light amount of the light radiated to the cylindrical sample may be 2,000 lumens, for example. At the third melting temperature, it is considered that the upper glaze layer composition starts melting and the glass structure of the upper glaze layer composition is completely loosened.

The lower limit value of the third melting temperature of the upper glaze layer composition may be 850° C. The upper limit value of third melting temperature of the upper glaze layer composition may be 1,150° C. The lower limit value of the third melting temperature of the upper glaze layer composition may be 870° C. The upper limit value of third melting temperature of the upper glaze layer composition may be 1,100° C. The lower limit value of the third melting temperature of the upper glaze layer composition may be 900° C. The upper limit value of third melting temperature of the upper glaze layer composition may be 1,050° C. When the third melting temperature of the upper glaze layer composition is equal to or higher than the above lower limit value (850° C. or higher), generation of bubbles when firing the upper glaze layer composition is easily inhibited. When the third melting temperature of the upper glaze layer composition is equal to or less than the above upper limit value (1,150° C. or less), the bubbles generated when firing the upper glaze layer composition are easily diffused into the atmosphere.

The third melting temperature of the upper glaze layer composition can be adjusted similarly to the first melting temperature of the upper glaze layer composition.

When the melting start temperature of the upper glaze layer 30 is determined from the sanitary ware 1 including the upper glaze layer 30, the first melting temperature and the second melting temperature are measured by the following measurement method 2-1.

<Measurement Method 2-1>

A DTA measurement is performed using alumina powder as a reference substance and the powder of the upper glaze layer 30 as a sample powder, and a DTA curve is obtained. In a region above 700° C. of the obtained DTA curve, a temperature of the reference substance at the earliest inflection point where a potential difference ΔV decreases is taken as the first melting temperature. The potential difference ΔV corresponds to a value ΔT obtained by subtracting a temperature of the reference substance from a temperature of the sample powder. The temperature of the reference substance at the earliest inflection point where the potential difference ΔV increases in a temperature region higher than the first melting temperature is taken as the second melting temperature.

The powder of the upper glaze layer 30 is obtained, by appropriately cutting and grinding the upper glaze layer 30. Conditions for the DTA measurement are the same as the conditions for the DTA measurement in the above measurement method 1-1. The first melting temperature of the upper glaze layer 30 is the same as the first melting temperature of the upper glaze layer composition. The second melting temperature of the upper glaze layer 30 is the same as the second melting temperature of the upper glaze layer composition. A difference between the second melting temperature and the first melting temperature of the upper glaze layer 30 is the same as the difference between the second melting temperature and the first melting temperature of the upper glaze layer composition (upper glaze layer melting temperature difference).

When the third melting temperature of the upper glaze layer 30 is obtained from the sanitary ware 1 including the upper glaze layer 30, the measurement is performed by the following measurement method 2-2.

<Measurement Method 2-2>

The powder of the upper glaze layer 30 is press-molded and obtains a cylindrical sample. Light is radiated while heating the obtained cylindrical sample. A light amount of the reflected light reflected by a surface of the cylindrical sample is measured. The earliest temperature at which the light amount of the reflected light becomes ten times or more the light amount of the reflected light detected at the beginning of glistening is taken as the third melting temperature.

The powder of the upper glaze layer 30 is obtained, by appropriately cutting and grinding the upper glaze layer 30. Conditions for obtaining the cylindrical sample are the same as the conditions for obtaining the cylindrical sample in the above measurement method 1-2. The third melting temperature of the upper glaze layer 30 is the same as the third melting temperature of the upper glaze layer composition.

In the present specification, “pore” means a pore actually contained in the upper glaze layer 30 or the intermediate layer 20. Pores are generated, for example, due to at least one of oxidation reactions, decomposition reactions, and voids or the like. The oxidation reactions and the decomposition reactions are generated based on the components contained in the upper glaze layer 30, the ceramics base material 10, and an intermediate layer composition. The voids are contained in the upper glaze layer 30, the ceramics base material 10, and the intermediate layer composition. The pores are counted by binarizing a brightness of an image using image processing software in the image obtained by observing a cut surface of the upper glaze layer 30 with a microscope or the like, and determining a relatively dark place as a pore. The size of the pores to be counted is set to be a diameter of 2 μm or more by converting the pores in the cut surface to a true circle.

The pores to be counted can be determined, for example, by the following procedure. The sanitary ware 1 is cut in a thickness direction of the upper glaze layer 30 by using a small sample cutter. The cut surface after cutting is observed with a microscope (DSX510, manufactured by Olympus Corporation) at a magnification of 125 times. In the observed image, the brightness of the image is binarized using image processing software, and one having a size of πμm2 (an area equivalent to a pore of 2 μm in diameter) or more in each area of a relatively dark place is detected as a pore.

The ratio of the area of the pores to the area of the cut surface obtained by cutting the upper glaze layer 30 in the thickness direction (hereinafter, also referred to as a “pore area ratio of the upper glaze layer 30”) may be 3% or less or 2% or less. When the pore area ratio of the upper glaze layer 30 is equal to or less than the above upper limit value (3% or less), irregular reflection of the light incident on the upper glaze layer 30 caused by the pores in the upper glaze layer 30 is easily inhibited. For this reason, the “depth” of the sanitary ware 1 is more easily improved. The lower limit value of the pore area ratio of the upper glaze layer 30 is not particularly limited, but may be 0.01% or more. The pore area ratio (%) of the upper glaze layer 30 can be obtained by dividing a total area (mm2) of the pores detected in the image observed using the above-mentioned microscope or the like by a visual field area (mm2) in the observed image.

The average pore size of pores in the cut surface obtained by cutting the upper glaze layer 30 in the thickness direction (hereinafter also referred to as an “average pore size of the upper glaze layer 30”) may be 50 μm or less. The average pore size of the upper glaze layer 30 may be 40 μm or less. The average pore size of the upper glaze layer 30 may be 30 μm or less. When the average pore size of pores in the cut surface of the upper glaze layer 30 is equal to or less than the above upper limit value (50 μm or less), irregular reflection of the light incident on the upper glaze layer 30 caused by the pores in the upper glaze layer 30 is easily inhibited. For this reason, the “depth” of the sanitary ware 1 is more easily improved. The lower limit value of the average pore size of the upper glaze layer 30 is 2 μm. The average pore size (μm) of the upper glaze layer 30 is an average value obtained such that, in the image observed using a microscope or the like described above, the pore size (diameter) is calculated in terms of a perfect circle from an area of each portion detected as a pore, and a total of the pore sizes is divided by the number of detected pores to obtain the average value.

The number of pores in the cut surface obtained by cutting the upper glaze layer 30 in the thickness direction (hereinafter, also referred to as a “number of pores in the cut surface of the upper glaze layer 30”) may be 120 or less per 1 mm2 The number of pores in the cut surface of the upper glaze layer 30 may be 100 or less. The number of pores in the cut surface of the upper glaze layer 30 may be 80 or less. When the number of pores in the cut surface of the upper glaze layer 30 is equal to or less than the above upper limit value (120 or less), irregular reflection of light incident on the upper glaze layer 30 caused by the pores in the upper glaze layer 30 is easily inhibited. For this reason, the “depth” of the sanitary ware 1 is more easily improved. The lower limit value of the number of pores in the cut surface of the upper glaze layer 30 is not particularly limited, but may be 1 or more. The number of pores (number/mm2) in the cut surface of the upper glaze layer 30 can be obtained by dividing the number of pores detected in the image observed using the above-described microscope or the like by a visual field area (mm2) in the observed image.

A thickness T30 of the upper glaze layer 30 may be, for example, 100 μm or more. The lower limit value of the thickness T30 may be 150 μm. The lower limit value of the thickness T30 may be 200 μm. The upper limit value of the thickness T30 may be 1000 μm. The upper limit value of the thickness T30 may be 800 μm. The upper limit value of the thickness T30 may be 600 μm. When thickness T30 is equal to or thicker than the above-mentioned lower limit value (100 μm or more), the surface of the upper glaze layer 30 is easily flattened. When thickness T30 is equal to or less than the above-mentioned upper limit value, the bubbles in the upper glaze layer composition are easily discharged outside of the upper glaze layer 30.

The thickness T30 of the upper glaze layer 30 can be determined, for example, by the following procedure. The sanitary ware 1 is cut in the thickness direction of the upper glaze layer 30 by using a small sample cutter. The cut surface after cutting is observed with a microscope (DSX510, manufactured by Olympus Corporation) at a magnification of 125 times. In the observed image, the distance between the surface of the upper glaze layer 30 and a boundary line (an upper-intermediate boundary line) between the upper glaze layer 30 and the intermediate layer 20 is measured at any 20 places. An arithmetic average value of the measured distances is taken as the thickness T30 of the upper glaze layer 30. The portions at which the sanitary ware 1 is cut are not particularly limited but portions easily seen by the human eye are preferable. Examples of the portions easily seen by human eyes include a bowl surface of a washbowl, a top surface of a washbowl, a top surface of a urinal, a rim portion of a toilet bowl, a bowl surface of a toilet bowl, a side surface of a toilet bowl and the like.

A difference T30Δ between the maximum value T30MAX of the thickness T30 of the upper glaze layer 30 and the minimum value T30MIN of the thickness T30 of the upper glaze layer 30 may be 50 μm or less. The difference T30Δ may be 40 μm or less. The difference T30Δ may be 30 μm or less. When the difference T30Δ is equal to or less than the above upper limit value (50 μm or less), irregular reflection of the light at an interface between the upper glaze layer 30 and the intermediate layer 20 is easily inhibited. As a result, the “depth” of the sanitary ware 1 is more easily improved. The lower limit value of the difference T30Δ is not particularly limited, but may be 0.1 μm or more.

A ratio of the difference T30Δ to the thickness T30 (hereinafter also referred to as a “T30Δ/T30 ratio”) may be 25% or less. The T30Δ/T30 ratio may be 20% or less. The T30Δ/T30 ratio may be 10% or less. When the T30Δ/T30 ratio is equal to or less than the upper limit value (25% or less), irregular reflection of the light at the interface between the upper glaze layer 30 and the intermediate layer 20 is easily inhibited. As a result, the “depth” of the sanitary ware 1 is more easily improved. The lower limit value of the T30Δ/T30 ratio is not particularly limited, but may be 0.01% or more.

The maximum value T30MAX of the thickness T30 and the minimum value T30MIN of the thickness T30 can be obtained, for example, by the following procedure. Similarly to the procedure for determining the thickness T30 of the upper glaze layer 30, the distance between the surfaces of the upper glaze layer 30 and the upper-intermediate boundary line is measured at any 20 places. Among the measured 20 places, one place with the largest distance between the surface of the upper glaze layer 30 and the upper-intermediate boundary line is taken as the maximum value T30MAX. Among the measured 20 places, one place with the smallest distance between the surface of the upper glaze layer 30 and the upper-intermediate boundary line is taken as the minimum value T30MIN.

The difference T30Δ can be controlled by flattening the interface between the upper glaze layer 30 and the intermediate layer 20. A smoothness of the interface between the upper glaze layer 30 and the intermediate layer 20 can be controlled by the melting start temperature of the intermediate layer composition, the average pore size at the cut surface obtained by cutting the intermediate layer 20 in the thickness direction, the ratio of the pore area to the area of the cut surface obtained by cutting the intermediate layer 20 in the thickness direction, and combinations thereof, which will be described later.

[Intermediate Layer]

The intermediate layer 20 is a fired material of an intermediate layer composition. The intermediate layer 20 is a layer including a glaze positioned between the ceramics base material 10 and the upper glaze layer 30. The intermediate layer composition is a slurry (a sludge) in which a raw material (intermediate layer raw material) forming the intermediate layer 20 is dispersed in water. The amount of water relative to a total mass of the intermediate layer composition may be 40 to 60% by mass. The amount of water relative to a total mass of the intermediate layer composition may be 40 to 50% by mass.

The intermediate layer 20 contains, for example, a crystal phase of the following substances. Examples are Al2O3, ZrO2, ZrO2-SiO2-based compounds, Al2O3-SiO2-based compounds, CaO-SiO2-based compounds, MgO-SiO2-based compounds, BaO-SiO2-based compounds, SrO-SiO2-based compounds, Na2O-Al2O3-SiO2-based compounds, K2O-Al2O3-SiO2-based compounds, CaO-Al2O3-SiO2-based compounds, MgO-Al2O3-SiO2-based compounds, BaO-Al2O3-SiO2-based compounds, SrO-Al2O3-SiO2-based compounds, etc., such as SiO2, Al2O3, ZrO2, Na2O, K2O, CaO, MgO, SrO and BaO compounds.

The intermediate layer 20 contains the above-mentioned crystal phase and is opaque. The upper glaze layer 30 is more transparent than the intermediate layer 20 because it does not contain a crystal phase.

The average particle size of the solid content contained in the intermediate layer composition may be 10 μm or less. The average particle size of the solid content contained in the intermediate layer composition may be 8 μm or less. The average particle size of the solid content contained in the intermediate layer composition may be 6 μm or less. When the average particle size of the solid content contained in the intermediate layer composition is equal to or less than the above upper limit value (10 μm or less), the melting start temperature of the solid content contained in the intermediate layer composition is easily lowered. The lower limit value of the average particle size of the solid content contained in the intermediate layer composition is not particularly limited, and is, for example, 0.05 μm or more. The average particle size of the solid content contained in the intermediate layer composition can be adjusted, for example, by grinding the intermediate layer raw material. An example of tool for grinding the intermediate layer raw material is a ball mill.

The average particle size of the solid content contained in the intermediate layer composition can be measured by the same method as the average particle size of the solid content contained in the upper glaze layer composition. The solid content contained in the intermediate layer composition is dried materials of the intermediate layer composition.

Examples of the intermediate layer composition include a composition containing 50 to 80% by mass of SiO2, 5 to 40% by mass of Al2O3, and 5 to 30% by mass of a total of Na2O, K2O, CaO, MgO and ZnO with respect to the total mass of the solid content contained in the intermediate layer composition. The total amount of each component of the solid content contained in an intermediate layer composition does not exceed 100% by mass with respect to the total mass of the solid content contained in the intermediate layer composition.

A composition of the intermediate layer composition may include 2 to 16 moles of SiO2 and 0 to 5 moles of Al2O3 as a molar ratio when the sum of the number of moles of Na2O, K2O, CaO, MgO, and ZnO is set to 1.

The intermediate layer composition may contain a frit. The lower limit value of the amount of the frit may be 0% by mass with respect to the total mass of the solid content contained in the intermediate layer composition. The upper limit value of the amount of the frit may be 30% by mass with respect to the total mass of the solid content contained in the intermediate layer composition. The upper limit value of the amount of the frit may be 20% by mass with respect to the total mass of the solid content contained in the intermediate layer composition.

The dried materials of the intermediate layer composition (hereinafter also referred to as the intermediate layer raw material) may be a mixture of the dried materials of the ceramics base material composition (hereinafter also referred to as the ceramics base material raw material) and the dried materials of the upper glaze layer composition (hereinafter referred to as the glaze raw material). When the intermediate layer material is a mixture of the ceramics base material and the glaze raw material, a mass ratio represented by the ceramics base material/the glaze raw material (hereinafter also referred to as a “ceramics base material/glaze ratio”) may be 20/80 to 80/20. The lower limit value of the ceramics base material/glaze ratio may be 30/70. The lower limit value of the ceramics base material/glaze ratio is 40/60. The upper limit value of the ceramics base material/glaze ratio may be 70/30. The upper limit value of the ceramics base material/glaze ratio may be 60/40. When the ceramics base material/glaze ratio is equal to or more than the above lower limit value (20/80 or more), adhesion between the ceramics base material 10 and the intermediate layer 20 is easily increased. When the ceramics base material/glaze ratio is equal to or less than the above upper limit value (80/20 or less), the interface between the intermediate layer 20 and the upper glaze layer 30 is easily flattened. From the viewpoint of further improving the “depth” of the sanitary ware 1, the intermediate layer raw material may be a mixture of the ceramics base raw material and the glaze raw material. The intermediate layer composition may be a mixture of the ceramics base material composition and the upper glaze layer composition which are mixed together to have the above ceramics base material/glaze ratio.

The intermediate layer composition may contain a pigment. The intermediate layer composition contains the pigment so that the intermediate layer 20 can be colored. By coloring the intermediate layer 20, the color of the ceramics base material 10 can be concealed. Examples of the pigment include zirconium silicate and aluminum oxide. When the intermediate layer composition contains the pigment, the lower limit value of the amount of the pigment may be 3% by mass with respect to the total mass of the solid content contained in the intermediate layer composition. The lower limit value of the amount of the pigment may be 6% by mass with respect to the total mass of the solid content contained in the intermediate layer composition. The upper limit value of the amount of the pigment may be 15% by mass with respect to the total mass of the solid content contained in the intermediate layer composition.

The melting start temperature of the intermediate layer composition can be defined as the first melting temperature. The lower limit value of the first melting temperature of the intermediate layer composition may be 850° C. The lower limit value of the first melting temperature of the intermediate layer composition may be 910° C. The lower limit value of the first melting temperature of the intermediate layer composition may be 930° C. The upper limit value of the first melting temperature of the intermediate layer composition may be 960° C. The upper limit value of the first melting temperature of the intermediate layer composition may be 950° C. When the first melting temperature of the intermediate layer composition is equal to or higher than the above lower limit value (850° C. or higher), generation of bubbles when firing the intermediate layer composition is easily inhibited. When the first melting temperature of the intermediate layer composition is equal to or less than the above upper limit value (960° C. or less), the interface between the upper glaze layer 30 and the intermediate layer 20 is easily flattened. The first melting temperature of the intermediate layer composition can be measured in the same manner as the first melting temperature of the upper glaze layer composition.

The lower limit value of the difference in temperature between the first melting temperature of the upper glaze layer composition and the first melting temperature of the intermediate layer composition (the first temperature difference) may be 10° C. The lower limit value of the first temperature difference may be 30° C. The lower limit value of the first temperature difference may be 60° C. The upper limit value of the first temperature difference is 120° C. The upper limit value of the first temperature difference may be 115° C. The upper limit value of the first temperature difference may be 110° C. When the first temperature difference is within the above numerical range (10 to 120° C.), the interface between the upper glaze layer 30 and the intermediate layer 20 is easily flattened. As a result, irregular reflection of the light at the interface between the upper glaze layer 30 and the intermediate layer 20 can be inhibited so that the “depth” of the sanitary ware 1 is more easily improved.

The lower limit value of the second melting temperature of the intermediate layer composition may be 1,090° C. The lower limit value of the second melting temperature of the intermediate layer composition may be 1,095° C. The lower limit value of the second melting temperature of the intermediate layer composition may be 1,100° C. The upper limit value of the second melting temperature of the intermediate layer composition may be 1,230° C. The upper limit value of the second melting temperature of the intermediate layer composition may be 1125° C. The upper limit value of the second melting temperature of the intermediate layer composition may be 1220° C. When the second melting temperature of the intermediate layer composition is equal to or higher than the above lower limit value (1,090° C. or higher), generation of bubbles when firing the intermediate layer composition is easily inhibited. When the second melting temperature of the intermediate layer composition is equal to or less than the above upper limit value (1,230° C. or less), the interface between the upper glaze layer 30 and the intermediate layer 20 is easily flattened. The second melting temperature of the intermediate layer composition can be measured in the same manner as the second melting temperature of the upper glaze layer composition.

The lower limit value of the difference in temperature between the second melting temperature of the upper glaze layer composition and the second melting temperature of the intermediate layer composition (the second temperature difference) may be 10° C. The lower limit value of the second temperature difference may be 100° C. The lower limit value of the second temperature difference may be 200° C. The upper limit value of the second temperature difference may be 330° C. The upper limit value of the second temperature difference may be 325° C. The upper limit value of the second temperature difference may be 320° C. When the second temperature difference is within the above numerical range (10 to 330° C.), the interface between the upper glaze layer 30 and the intermediate layer 20 is easily flattened. As a result, irregular reflection of the light at the interface between the upper glaze layer 30 and the intermediate layer 20 can be inhibited so than the “depth” of the sanitary ware 1 is more easily improved.

The lower limit value of the difference between the second melting temperature and the first melting temperature of the intermediate layer composition (an intermediate layer melting temperature difference) may be 50° C. The lower limit value of the intermediate layer melting temperature difference may be 100° C. The lower limit value of the intermediate layer melting temperature difference may be 230° C. The upper limit value of the intermediate layer melting temperature difference may be 300° C. When the intermediate layer melting temperature difference is equal to or higher than the above lower limit value (50° C. or more), the average pore size of pores generated when firing the intermediate layer composition is easily reduced. When the intermediate layer melting temperature difference is equal to or less than the above upper limit value (300° C. or less), generation of bubbles when firing the intermediate layer composition is easily inhibited. The intermediate layer melting temperature difference is determined by subtracting the first melting temperature of the intermediate layer composition from the second melting temperature of the intermediate layer composition.

The first melting temperature of the intermediate layer composition can be adjusted on the basis of a type of intermediate layer material, a blending proportion of the intermediate layer material, the average particle size of the solid content of the intermediate layer composition, and combinations thereof. The second melting temperature of the intermediate layer composition can be adjusted similarly to the first melting temperature of the intermediate layer composition.

When obtaining the melting start temperature of the intermediate layer 20 from the sanitary ware 1 including the intermediate layer 20, the first melting temperature and the second melting temperature are measured, by using the powder of the intermediate layer 20 as a sample powder, on the basis of the same method as the measurement method 2-1. The powder of the intermediate layer 20 is obtained, for example, by appropriately cutting and grinding the intermediate layer 20. The first melting temperature of the intermediate layer 20 is the same as the first melting temperature of the intermediate layer composition. The second melting temperature of the intermediate layer 20 is the same as the second melting temperature of the intermediate layer composition. The difference between the second melting temperature and the first melting temperature of the intermediate layer 20 is the same as the difference between the second melting temperature and the first melting temperature of the intermediate layer composition (intermediate layer melting temperature difference).

A ratio of the area of the pores to the area of the cut surface obtained by cutting the intermediate layer 20 in the thickness direction (hereinafter, also referred to as a “pore area ratio of the intermediate layer 20”) may be 20% or less. The pore area ratio of the intermediate layer 20 may be 15% or less. The pore area ratio of the intermediate layer 20 may be 12% or less. When the pore area ratio of the intermediate layer 20 is equal to or less than the above upper limit value (20% or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 can be inhibited so that the “depth” of the sanitary ware 1 is more easily improved. A lower limit value of the pore area ratio of the intermediate layer 20 is not particularly limited, but may be 1.0% or more. The pore area ratio of the intermediate layer 20 is determined by the same method as the pore area ratio of the upper glaze layer 30.

The average pore size of pores in the cut surface obtained by cutting the intermediate layer 20 in the thickness direction (hereinafter also referred to as an “average pore size of pores in the cut surface of the intermediate layer 20”) may be 25 μm or less, 20 μm or less, or 15 μm or less. When the average pore size of pores in the cut surface of the intermediate layer 20 is equal to or less than the upper limit value (25 μm or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 can be suppressed so that the “depth” of the sanitary ware 1 is more easily improved. A lower limit value of the average pore size of pores in the cut surface of the intermediate layer 20 is 2 μm. The average pore size of pores in the cut surface of the intermediate layer 20 is determined by the same method as the average pore size of pores in the cut surface of the upper glaze layer 30.

A number of pores in the cut surface obtained by cutting the intermediate layer 20 in the thickness direction (hereinafter, also referred to as a “number of pores in the cut surface of the intermediate layer 20”) may be 1,000 or less per 1 mm2, 700 or less, or 500 or less. When the number of pores in the cut surface of the intermediate layer 20 is equal to or less than the above upper limit value (1,000 or less), irregular reflection of the light incident on the upper glaze layer 30 caused by the pores in the intermediate layer 20 is easily inhibited. As a result, the irregular reflection of the light at the interface between the upper glaze layer 30 and the intermediate layer 20 can be suppressed so that the “depth” of the sanitary ware 1 is more easily improved. The lower limit value of the number of pores in the cut surface of the intermediate layer 20 is not particularly limited, but may be one or more. The number of pores in the cut surface of the intermediate layer 20 can be counted by the same method as the number of pores in the cut surface of the upper glaze layer 30.

A thickness T20 of the intermediate layer 20 may be, for example, 200 μm or more, 200 to 1,000 μm, 250 to 800 μm, or 300 to 600 μm. When the thickness T20 is equal to or more than the above lower limit value (200 μm or more), the interface between the intermediate layer 20 and the upper glaze layer 30 is easily flattened. When the thickness T20 is equal to or less than the above upper limit value, the bubbles in the intermediate layer composition are easily discharged outside of the intermediate layer 20.

The thickness T20 of the intermediate layer 20 can be determined, for example, by the following procedure. The sanitary ware 1 is cut in the thickness direction of the intermediate layer 20 by using a small sample cutter. The cut surface after cutting is observed with a microscope (DSX510, manufactured by Olympus Corporation) at a magnification of 125 times. In the observed image, a distance between the boundary line between the upper glaze layer 30 and the intermediate layer 20 (upper-intermediate boundary line) and a boundary line between the intermediate layer 20 and the ceramics base material 10 (an intermediate-ceramics base material boundary line) is measured at any 20 places. An arithmetic average value of the measured distances is taken as the thickness T20 of the intermediate layer 20.

A difference T20Δ between the maximum value T20MAX of the thickness T20 of the intermediate layer 20 and the minimum value T20MIN of the thickness T20 of the intermediate layer 20 may be 50 μm or less. The difference T20Δ may be 40 μm or less. The difference T20Δ may be 30 μm or less. When the difference T20Δ is equal to or less than the above upper limit value (50 μm or less), irregular reflection of the light at the interface between the upper glaze layer 30 and the intermediate layer 20 is easily inhibited. As a result, the “depth” of the sanitary ware 1 is more easily improved. The lower limit value of the difference T20Δ is not particularly limited, but may be 0.1 μm or more.

The ratio of the difference T20Δ to the thickness T20 (hereinafter also referred to as a “T20Δ/T20 ratio”) may be 25% or less. The T20Δ/T20 ratio may be 20% or less. The T20Δ/T20 ratio may be 10% or less. When the T20Δ/T20 ratio is equal to or less than the upper limit value (25% or less), irregular reflection of the light at the interface between the upper glaze layer 30 and the intermediate layer 20 is easily inhibited. As a result, the “depth” of the sanitary ware 1 is more easily improved. The lower limit value of the T20Δ/T20 ratio is not particularly limited, but may be 0.01% or more.

The maximum value T20MAX of the thickness T20 and the minimum value T20MIN of the thickness T20 can be obtained, for example, by the following procedure. Similarly to the procedure for determining the thickness T20 of the intermediate layer 20, the distance between the upper-intermediate boundary line and the intermediate-ceramics base material boundary line is measured at any 20 places. Among the measured 20 places, one place with the largest distance between the upper-intermediate boundary line and the intermediate-ceramics base material boundary line is taken as the maximum value T20MAX. Among the measured 20 places, one place with the smallest distance between the upper-intermediate boundary and the intermediate-ceramics base material boundary line is defined as the minimum value T20MIN.

[Method of Manufacturing Sanitary Ware]

Next, a method of manufacturing the sanitary ware 1 of the present embodiment will be described. First, a ceramics base material 10 is prepared. The ceramics base material 10 may not be only a molded product obtained by molding the ceramics base material composition, but may also be a molded product obtained by firing and molding the ceramics base material composition or be a commercial product which has been molded or molded and fired in advance. In the case of firing the ceramics base material composition, the lower limit value of the firing temperature may be, for example, 1,100° C. The lower limit value of the firing temperature may be 1150° C. The upper limit value of the firing temperature may be 1,300° C. The upper limit value of the firing temperature may be 1,250° C. When the firing temperature is equal to or higher than the above lower limit value (1,100° C. or more), the strength of the ceramics base material 10 is easily increased. When the firing temperature is equal to or less than the above upper limit value (1,300° C. or less), deformation of the ceramics base material 10 is easily inhibited.

Next, the intermediate layer composition is applied to the surface of the ceramics base material 10. A method of applying the intermediate layer composition to the surface of the ceramics base material 10 is not particularly limited, and a general method such as dipping, pouring, spraying, or coating can be appropriately selected. From the viewpoint of securing the thickness of the intermediate layer 20, the method of applying the intermediate layer composition to the surface of the ceramics base material 10 may be any of dipping, pouring, applying, or spraying. From the viewpoint of easily making the thickness of the intermediate layer 20 uniform, the spraying is preferable as the method of applying the intermediate layer composition to the surface of the ceramics base material 10. A dip coating method is an exemplary example of the dipping. A spray coating method is an exemplary example of the spraying.

The application amount of the intermediate layer composition is not particularly limited, and may be adjusted so that the thickness of the intermediate layer 20 after firing is 200 μm or more. The application amount of the intermediate layer composition can be adjusted by appropriately adjusting the water content of the intermediate layer composition, a viscosity of the intermediate layer composition, the average particle size of the solid content contained in the intermediate layer composition, or the like. By applying the intermediate layer composition to the surface of the ceramics base material 10, a primary coated body is obtained.

The upper glaze layer composition is easily applied to the surface of the primary coated body by drying the primary coated body. For this reason, the primary coated body may be dried. The lower limit value of the temperature for drying the primary coated body may be 20° C. The lower limit value of the temperature for drying the primary coated body may be 30° C. The lower limit value of the temperature for drying the primary coated body may be 40° C. The upper limit value of the temperature for drying the primary coated body may be 110° C. The upper limit value of the temperature for drying the primary coated body may be 100° C. The upper limit value of the temperature for drying the primary coated body may be 90° C. When the temperature at the time of drying the primary coated body is equal to or higher than the above lower limit value (30° C. or more), the water content of the intermediate layer composition is easily reduced. When the temperature at the time of drying the primary coated body is equal to or less than the above upper limit value (100° C. or less), the surface of the intermediate layer 20 is easily flattened. The lower limit value of the time for drying the primary coated body may be 0.5 hours. The upper limit value of the time for drying the primary coated body may be 48 hours. When the time for drying the primary coated body is equal to or more than the above lower limit value, the intermediate layer composition is easily and sufficiently dried. When the time for drying the primary coated body is equal to or less than the above upper limit value, productivity of the sanitary ware 1 is easily improved.

Next, the upper glaze layer composition is applied to the surface of the primary coated body. From the viewpoint of making it easy to adjust the thickness of the upper glaze layer 30, the method of applying the upper glaze layer composition may be spraying.

The application amount of the upper glaze layer composition is not particularly limited, and may be adjusted so that the thickness of the upper glaze layer 30 after firing is 100 μm or more. The application amount of the upper glaze layer composition may be adjusted by appropriately adjusting the water amount of the upper glaze layer composition, the viscosity of the upper glaze layer composition, the average particle size of the solid content contained in the upper glaze layer composition, or the like. By applying the upper glaze layer composition to the surface of the primary coated body, a secondary coated body is obtained.

Next, the secondary coated body is fired. As a firing temperature at the time of firing the secondary coated body, a temperature at which the ceramics base material 10 is sintered and the intermediate layer composition and the upper glaze layer composition are softened is preferable. The lower limit value of the firing temperature for firing the secondary coated body may be, for example, 1,100° C. The lower limit value of the firing temperature for firing the secondary coated body may be 1150° C. The upper limit value of the firing temperature for firing the secondary coated body may be 1,300° C. The upper limit value of the firing temperature for firing the secondary coated body may be 1,250° C. When the firing temperature at the time of firing the secondary coated body is equal to or higher than the above lower limit value (1,150° C. or more), the upper glaze layer composition is easily and sufficiently melted. In addition, when the firing temperature at the time of firing the second coated body is the above lower limit value or more (1,150° C. or more), the intermediate layer composition is easily and sufficiently melted. When the firing temperature at the time of firing the secondary coated body is equal to or less than the above upper limit value (1,250° C. or less), the surface of the upper glaze layer 30 is easily flattened. Further, when the firing temperature at the time of firing the second coated body is equal to or less than the above upper limit value or less (1,250° C. or less), the interface between the intermediate layer 20 and the upper glaze layer 30 is easily flattened.

The lower limit value of the firing time for firing the secondary coated body may be 1 hour. The lower limit value of the firing time for firing the secondary coated body may be 2 hours. The lower limit value of the firing time for firing the secondary coated body may be 3 hours. The upper limit value of the firing time for firing the secondary coated body may be 168 hours. The upper limit value of the firing time for firing the secondary coated body may be 72 hours. The lower limit value of the firing time for firing the secondary coated body may be 24 hours. When the firing time for firing the secondary coated body is equal to or more than the above lower limit value (1 hour or more), the surface of the upper glaze layer 30 is easily flattened. In addition, when the firing time for firing the second coated body is equal to or more than the above lower limit value (1 hour or more), the interface between the intermediate layer 20 and the upper glaze layer 30 is easily flattened. When the firing time for firing the secondary coated body is equal to or less than the above upper limit value (168 hours or less), productivity of the sanitary ware 1 is easily improved.

A fired product is obtained by firing the second coated body. The fired product is cooled, thereby the sanitary ware 1 is obtained. The sanitary ware 1 may be obtained by naturally cooling the fired product, or may be obtained by cooling such as blowing air. The lower limit value of the temperature for cooling the fired product may be 800° C. The lower limit value of the temperature for cooling the fired product may be 900° C. The upper limit value of the temperature for cooling the fired product may be 1,300° C. The upper limit value of the temperature for cooling the fired product may be 1,250° C. When the temperature range at the time of cooling the fired product is equal to or higher than the above lower limit value (800° C. or more), the bubbles are easily discharged outside of the upper glaze layer 30. When the temperature range at the time of cooling the fired product is equal to or less than the above upper limit value (1,300° C. or less), the surface of the upper glaze layer 30 is easily flattened. The cooling rate when cooling the fired product may be 30° C./minute or less. The cooling rate when cooling the fired product may be 10° C./minute or less. The cooling rate when cooling the fired product may be 0.1° C./minute or less. When the cooling rate at the time of cooling the fired product is less than or equal to the above upper limit value (30° C./minute or less), the bubbles are discharged outside of the upper glaze layer 30. In addition, when the cooling rate at the time of cooling the fired product is equal to or less than the above upper limit value (30° C./minute or less), the surface of the upper glaze layer 30 is easily flattened.

The sanitary ware 1 may be obtained by applying the intermediate layer composition to the surface of the ceramics base material 10 through dipping, pouring, applying, or spraying, and then firing it to obtain a primary fired body (the first firing step), and applying the upper glaze layer composition to the primary fired body and firing it (the second firing step).

The lower limit value of the firing temperature of the first firing step may be 800° C. The lower limit value of the firing temperature of the first firing step may be 850° C. The upper limit value of the firing temperature of the first firing step may be 1,000° C. The lower limit value of the firing temperature of the first firing step may be 950° C. When the firing temperature of the first firing step is equal to or higher than the above lower limit value (800° C. or more), the intermediate layer composition is easily and sufficiently melted. In addition, degassing of the ceramics base material 10 and the intermediate layer 20 is performed so that the mixing of the pores into the upper glaze layer 30 is easily inhibited. When the firing temperature in the first firing step is equal to or less than the above upper limit value (1,000° C. or less), the surface of the intermediate layer 20 is easily flattened, and the adhesion to the upper glaze layer composition is easily improved. The lower limit value of the firing time of the first firing step may be 1 hour. The lower limit value of the firing time of the first firing step may be 2 hours. The lower limit value of the firing time of the first firing step may be 3 hours. The upper limit value of the firing time of the first firing step may be 168 hours. The upper limit value of the firing time of the first firing step may be 72 hours. The upper limit value of the firing time of the first firing step may be 24 hours. When the firing time of the first firing step is equal to or more than the above lower limit value (one hour or more), the surface of the intermediate layer 20 is easily flattened. In addition, degassing of the ceramics base material 10 and the intermediate layer 20 is performed so that the mixing of the pores into the upper glaze layer 30 is easily inhibited. When the firing time of the first firing step is equal to or less than the above upper limit value (168 hours or less), productivity of the sanitary ware 1 is easily improved. The primary fired body is obtained by firing the primary coated body.

The primary fired body may be cooled before applying the upper glaze layer composition. The lower limit value of the temperature for cooling the primary fired body may be 800° C. The lower limit value of the temperature for cooling the primary fired body may be 850° C. The upper limit value of the firing temperature for firing the secondary coated body may be 1,000° C. The upper limit value of the firing temperature for firing the secondary coated body may be 950° C. When the temperature at the time of cooling the primary fired body is equal to or higher than the above lower limit value (800° C. or more), the bubbles are discharged outside of the intermediate layer 20. When the temperature at the time of cooling the primary fired body is equal to or less than the above upper limit value (1,000° C. or less), the surface of the intermediate layer 20 is easily flattened. The cooling rate when cooling the primary fired body may be 30° C./minute or less, The cooling rate when cooling the primary fired body may be 10° C./minute or less. When the cooling rate at the time of cooling the primary fired body is equal to or less than the above upper limit value (30° C./minute or less), the bubbles are easily discharged outside of the intermediate layer 20. In addition, when the cooling rate at the time of cooling the primary fired body is equal to or less than the above upper limit value (30° C./minute or less), the surface of the intermediate layer 20 is easily flattened.

Next, the upper glaze layer composition is applied to the surface of the primary fired body. From the viewpoint of making it easy to adjust the thickness of the upper glaze layer 30, the method of applying the upper glaze layer composition to the surface of the primary fired body may be spraying. The application amount of the upper glaze layer composition to the surface of the primary fired body is the same as the application amount of the upper glaze layer composition to the surface of the primary coated body. By applying the upper glaze layer composition to the surface of the primary fired body, the secondary coated body is obtained.

Next, the secondary coated body is fired (second firing step). The lower limit value of the firing temperature of the second firing step may be 1,100° C. The lower limit value of the firing temperature of the second firing step may be 1150° C. The upper limit value of the firing temperature for firing the secondary coated body may be 1,300° C. The upper limit value of the firing temperature for firing the secondary coated body may be 1,250° C. When the firing temperature in the second firing step is equal to or higher than the above lower limit value (1,100° C. or more), the upper glaze layer composition is easily and sufficiently melted. When the firing temperature in the second firing step is equal to or less than the above upper limit value (1,300° C. or less), the surface of the upper glaze layer 30 is easily flattened. The lower limit value of the firing time of the second firing step may be 1 hour. The lower limit value of the firing time of the second firing step may be 2 hours. The lower limit value of the firing time of the second firing step may be 3 hours. The upper limit value of the firing time of the second firing step may be 168 hours. The upper limit value of the firing time of the second firing step may be 72 hours. The upper limit value of the firing time of the second firing step may be 24 hours. When the firing time of the second firing step is equal to or more than the above lower limit value (one hour or more), the surface of the upper glaze layer 30 is easily flattened. When the firing time of the second firing step is equal to or less than the above upper limit value (168 hours or less), productivity of the sanitary ware 1 is easily improved. The fired product is obtained through the second firing step. The fired product is cooled thereby the sanitary ware 1 is obtained. The temperature for cooling the fired product is the same as the temperature for cooling the fired product described above. The cooling rate at the time of cooling the fired product is the same as that at the time of cooling the fired product described above.

By obtaining the sanitary ware 1 via the primary fired body, the interface between the intermediate layer 20 and the upper glaze layer 30 is more easily flattened. The number of pores contained in the intermediate layer 20 and the upper glaze layer 30 is easily reduced. For this reason, the “depth” of the sanitary ware 1 is more easily improved. From the viewpoint of easily improving the “depth” of the sanitary ware 1, the method of manufacturing the sanitary ware of the present embodiment may obtain the sanitary ware 1 via the primary fired body.

In the embodiment described above, the sanitary ware 1 includes the ceramics base material 10, the intermediate layer 20, and the upper glaze layer 30. However, the disclosure is not limited to the embodiment described above, and, for example, the sanitary ware may not have the intermediate layer. That is, the sanitary ware may have a form in which the upper glaze layer (glaze layer) is provided on the surface of the ceramics base material. Another glaze layer may be provided between the upper glaze layer 30 and the intermediate layer 20. The glaze layer may include a plurality of layers. That is, the sanitary ware may be a form in which the intermediate layer is provided on the surface of the ceramics base material, a single layer or multiple layers of the glaze layer is provided on the intermediate layer, and the upper glaze layer (glaze layer) are provided on the intermediate layer. From the viewpoint of further improving the “depth” of the sanitary ware, the sanitary ware may include the intermediate layer. In the case where the sanitary ware does not have an intermediate layer, the thickness of the upper glaze layer (glaze layer) can be determined, for example, by the following procedure. The sanitary ware is cut in the thickness direction of the upper glaze layer by using a small sample cutter. The cut surface after cutting is observed with a microscope (DSX510, manufactured by Olympus Corporation) at a magnification of 125 times. In the observed image, the distance between the surface of the upper glaze layer and a boundary line between the upper glaze layer and the ceramics base material (an upper-ceramics base material boundary line) is measured at any 20 places. An arithmetic average value of the measured distances is taken as the thickness of the upper glaze layer.

[Depth]

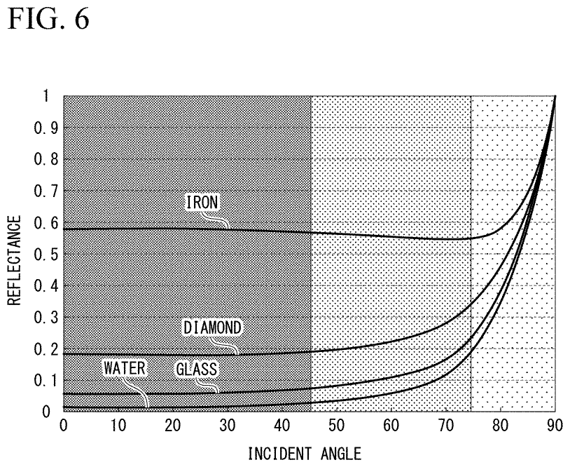

Next, the “depth” of the washbowl 100 formed in the above-described sanitary ware 1 will be described. FIG. 6 shows Fresnel reflectance of iron, diamond, glass, and water. Fresnel reflectance indicates a relationship between an incident angle and a reflectance rate. In a range where Fresnel reflectance changes rapidly, a light reflection changes, thereby the “depth” is tend to be strongly felt. In FIG. 6, fine dots indicate a region where the incident angle is 0 degrees to about 45 degrees and Fresnel reflectance hardly changes, rough dots indicate a region where the incident angle is about 75 degrees or more and Fresnel reflectance changes rapidly, and middle dots indicate a region where the incident angle is about 45 degrees to about 75 degrees and Fresnel reflectance slightly changes. Size of the middle dots are between sizes of the fine dots and the rough dots. The graph which shows Fresnel reflectance of the upper glaze layer 30 becomes a curve similar to the glass shown in FIG. 6.

The upper glaze layer 30 is transparent, has few pores, and does not have any interference with light incidence. The light passing through the upper glaze layer 30 is less disturbed at the interface between the transparent upper glaze layer 30 and the opaque intermediate layer 20, so that it is easy to feel the “depth”.

That is, while the user M enters the washroom and moves from a position standing by the wall to a position approaching the washbowl 100, the user M passes through the area where the Fresnel reflectance changes rapidly, whereby the user M can feel the “depth”. In the present embodiment, by setting the angle (edge angle) X1 to about 45 degrees, the user M can pass through a region where the Fresnel reflectance rapidly changes in the process of approaching the washbowl 100.

When the Fresnel reflectance is high or the change of the Fresnel reflectance is felt, it is easy to feel the depth. In the washbowl 100 configured as described above, the upper glaze layer 30 is more transparent than the intermediate layer 20, and the angle (edge angle) X1 is about 45 degrees, whereby the user M passes through the region where the Fresnel reflectance changes rapidly while the user M enters the washroom and moves from a position standing by the wall to a position approaching the wash bowl 100. For this reason, the user M can feel the “depth”.

The end portion 101a on the front side of the curved surface 101u of the bowl portion 101 constitutes the circumferential edge portion 104 of the bowl portion 101. That is, there is no wall portion standing upward from the end portion 101a, a wall portion extending to the user M side, or the like, at the end portion 101a on the front side of the curved surface 101u of the bowl portion 101. Therefore, when the user M uses the washbowl 100, since the curved surface 101u of the washbowl 100 is viewed along the extension of the tangent to the end portion 101a of the surface (curved surface) 101u, the effect that the user M feels the “depth” can be further enhanced.

Since the tangent to the end portion 101a on the front side of the curved surface 101u of the bowl portion 101 is formed at 35 degrees or more with respect to the horizontal plane, the effect that the user M feels the “depth” can be further enhanced. Since the tangent to the end portion 101a on the front side of the curved surface 101u of the bowl portion 101 is formed at 45 degrees or less with respect to the horizontal plane, the effect that the user M feels the “depth” can be further enhanced.

### Modified Example 1

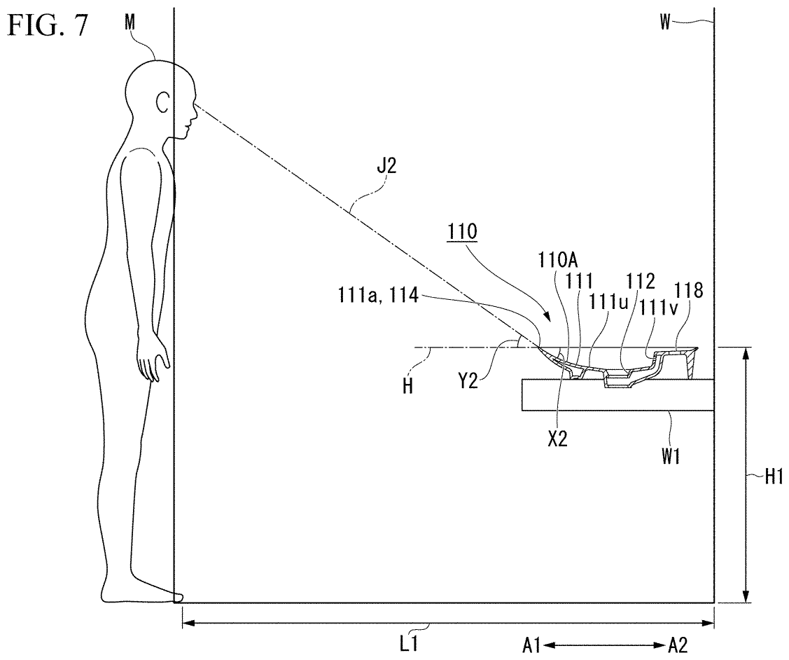

FIG. 7 shows the washbowl in the sectional view. In the following description of modified examples, the same members as those described above are denoted by the same reference numerals, and the description thereof will be omitted.

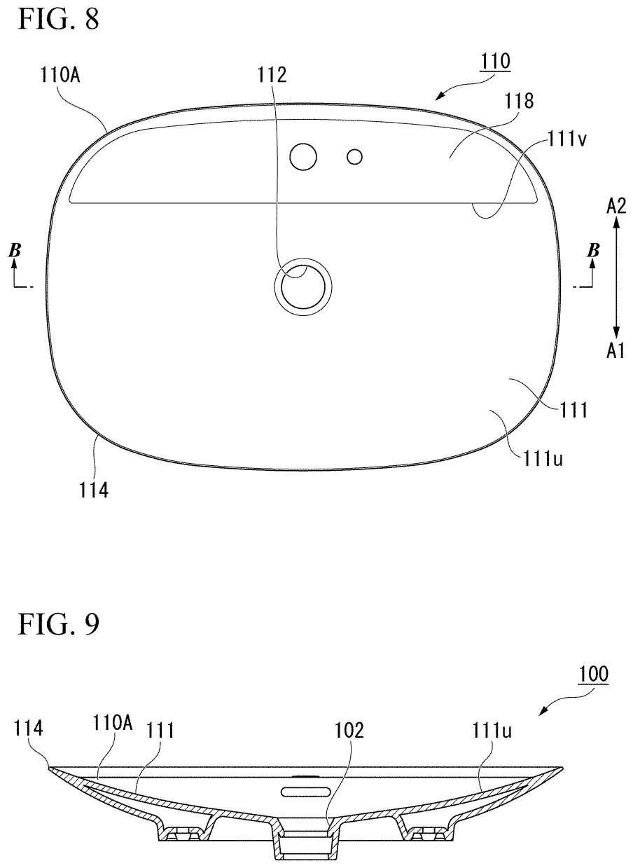

In the present modified example, as shown in FIGS. 7 to 9, the washbowl 110 has a washbowl body 110A. The washbowl body 110A has a bowl portion 111 in which a recessed portion recessed downward is formed, and a flat portion 118 formed to be substantially flat. The washbowl 110 has a substantially rectangular shape in a plan view. The washbowl 110 has four corners formed in a curved shape.

A drainage port 112 is provided substantially at a center of the bowl portion 111 in a plan view.

A surface of the bowl portion 111 is formed by a curved surface 111u and a back side standing surface 111v. The curved surface 111u continuously recess downward. The curved surface 111u is inclined downward from the circumferential edge portion 114, except for the back side of the bowl portion 111, toward the center side in a plan view.

The back side standing surface 111v is provided to stand upward from an end portion on the back side of the curved surface 111u. The flat portion 118 is provided at an upper end portion of the back side standing surface 111v. The flat portion 118 has an upper surface formed substantially horizontally.

An end portion 111a on the front side of the curved surface 111u of the bowl portion 111 constitutes the circumferential edge portion 114 of the bowl portion 111. That is, a wall portion standing upward from the end portion 111a, a wall portion extending to the front side, or the like are not provided at the end portion 111a on the front side of the curved surface 111u of the bowl portion 111.

In the present modified example, an angle X2 between a tangent to the end portion 111a on the front side of the curved surface 111u of the bowl portion 111 and the horizontal plane H is about 35 degrees.

In the case of a house with a Japanese standard scale module, when the user M with a height of about 170 cm enters the washroom, an angle Y2 between a line of sight J2 directed from the user M toward the end portion 111a of the washbowl 110 and the horizontal plane H is substantially the same as the angle X2. Accordingly, the line of sight J2 of the user M along the curved surface 111u from the end portion 111a of the bowl portion 111.

In the washbowl 110 configured as described above, the user M passes through the region where the Fresnel reflectance changes rapidly while the user M enters the washroom and moves from a position standing by the wall to a position capable of using the wash bowl 110. For this reason, the user M can feel the “depth”. The effect is brought by which the upper glaze layer 30 is more transparent than the intermediate layer 20, and the angle (edge angle) X2 is about 35 degrees.

### Modified Example 2

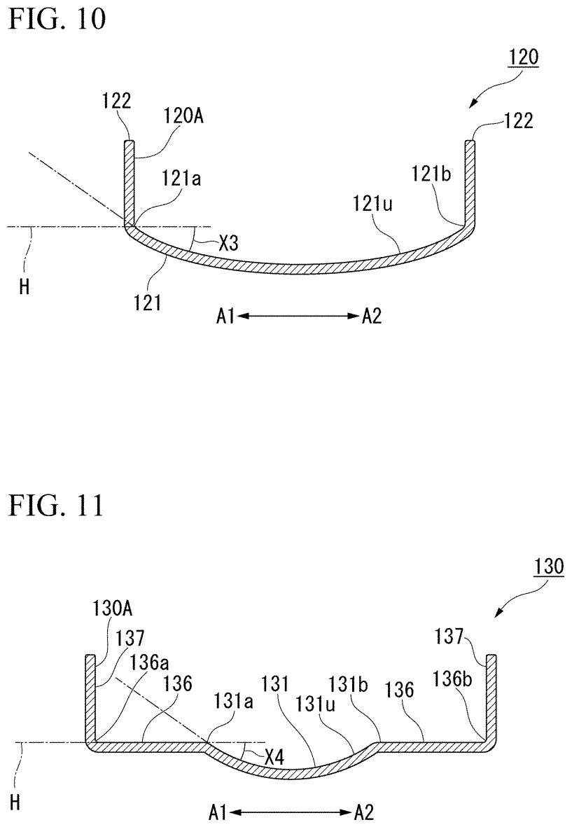

In the present modified example, as shown in FIG. 10, the washbowl 120 has a washbowl body 120A. The washbowl body 120A has a bowl portion 121 in which a recessed portion recessed downward is formed, and standing wall portions 122.

A surface of the bowl portion 121 is formed by a continuous curved surface 121u continuous to recess downward. The curved surface 121u is inclined downward toward a center side thereof in a plan view.

The standing wall portions 122 stand upward from an end portion 121a on the front side and an end portion 121b on the back side of the curved surface 121u of the bowl portion 121, respectively. The standing wall portions 122 may extend in a width direction (a left to right direction viewed from the user M when the user M uses the bowl portion 121) from the end portions 121a and 121b of the bowl portion 121.

An angle X3 between a tangent to the end portion 121a on the front side of the curved surface 121u of the bowl portion 121 and the horizontal plane H is about 35 degrees.

In the washbowl 120 configured as described above, since the upper glaze layer 30 is more transparent than the intermediate layer 20, and the angle X3 is about 35 degrees, the user M passes through the region where the Fresnel reflectance changes rapidly while the user M enters the washroom and moves from a position standing by the wall to a position capable of using the wash bowl 120. For this reason, the user M can feel the “depth”.

### Modified Example 3

In the present modified example, as shown in FIG. 11, the washbowl 130 has a washbowl body 130A. The washbowl body 130A has a bowl portion 131 in which a recessed portion recessed downward is formed, flat portions 136, and standing wall portions 137.

A surface of the bowl portion 131 is formed by a continuous curved surface 131u recessed downward. The curved surface 131u is inclined downward toward a center side thereof in a plan view.

The flat portions 136 are provided at an end portion 131a on the front side and an end portion 131b on the back side of the curved surface 131u, respectively. The flat portion 136 has an upper surface formed substantially horizontally.

The standing wall portions 137 stand upward from an end portion 136a on the front side and an end portion 136b on the back side of the flat portion 136, respectively. The flat portion 136 and the standing wall portion 137 may extend in the width direction. An angle X4 between a tangent to the end portion 131a and the horizontal plane H is about 35 degrees.

In the washbowl 130 configured as described above, the upper glaze layer 30 is more transparent than the intermediate layer 20, and the angle X4 is about 35 degrees, whereby the user M passes through the region where the Fresnel reflectance changes rapidly while the user M enters the washroom and moves from a position standing by the wall to a position capable of using the wash bowl 130. For this reason, the user M can feel the “depth”.

When the Fresnel reflectance is high or a change in the Fresnel reflectance is felt, human beings easily feel the depth. In the washbowl configured as described above, the upper glaze layer is more transparent than the intermediate layer, and an angle between the tangent to the inclined surface and the horizontal plane is set to be 5 degrees to 75 degrees, whereby the user passes through a region where the Fresnel reflectance changes rapidly while approaching an available position with respect to the washbowl. For this reason, the effect that the user feels the “depth” can be obtained.

In the washbowl configured as described above, the end portion on the front side in the continuous inclined surface constitutes the circumferential edge portion of the bowl portion. That is, a wall portion standing upward from the end portion on the front side, a wall portion extending to a user side, or the like are not provided at the end portion on the front side of the inclined surface. Therefore, when the user uses the washbowl, since the inclined surface of the washbowl is viewed along an extension line, the effect that the user feels the “depth” can be further enhanced. The extension line is a line extended along the tangent of a curved surface of the washbowl.

In the washbowl configured as described above, since the tangent to the end portion on the front side in the continuous inclined surface is formed at 35 degrees or more with respect to the horizontal plane, the effect that the user feels the “depth” can be further enhanced. Since the tangent to the end portion on the front side in the continuous inclined surface is formed at 45 degrees or less with respect to the horizontal plane, the effect that the user feels the “depth” can be further enhanced

In Examples A to G and Comparative Examples A and B, the “depth” was evaluated under the conditions shown in Table 1 below for the position viewed by the user M, the washbowl edge angle, and the incident angle. In Examples A to G, a washbowl having the same glaze configuration as that of Example E4, which will be described later, was used.

TABLE 1

| | EXAMPLE | | | | | |
|---|---|---|---|---|---|---|
| | COMPARATIVE | EXAMPLE | EXAMPLE | | | EXAMPLE |
| | EXAMPLE A | A | B | EXAMPLE C | EXAMPLE D | E |
| OBSERVING | 45 DEGREES OF LINE OF SIGHT AT WALL SIDE OF WASHROOM | | | | | |
| POSITION | | | | | | |
| WASHBOWL EDGE | 1 | 5 | 20 | 35 | 45 | 55 |
| ANGLE | | | | | | |
| (DEGREES) | | | | | | |
| INCIDENT ANGLE | 46 | 50 | 65 | 80 | 90 | 70 |
| (DEGREES) | | | | | | |
| EVALUATION | NG | OK | OK | EXCELLENT | EXCELLENT | OK |

| | EXAMPLE | | |
|---|---|---|---|
| | EXAMPLE F | EXAMPLE G | COMPARATIVE EXAMPLE B |
| OBSERVING | 75 DEGREES OF LINE OF SITE AT | | |
| POSITION | CENTER OF WASHROOM | | |
| WASHBOWL EDGE | 65 | 75 | 85 |
| ANGLE | | | |
| (DEGREES) | | | |
| INCIDENT ANGLE | 80 | 90 | — |
| (DEGREES) | | | |
| EVALUATION | EXCELLENT | EXCELLENT | — |

In evaluating the “depth”, in the region (rough dots) where the Fresnel reflectance shown in FIG. 6 changes rapidly, since the reflection of light changes as the user M slightly shifts his line of sight, it was evaluated as “EXCELLENT” as a result of strongly feeling the “depth”. In the region (fine dots) where the Fresnel reflectance hardly changes, since there was no reflection of light even if the user M shifted his line of sight, it was evaluated as “NG” as a result of not feeling the “depth”. In the region (intermediate dots between the above two dots) where the Fresnel reflectance slightly changes, since the reflection of light changes when the user M shifts his line of sight to some extent, it was evaluated as “OK” as a result of feeling the “depth.”

As shown in Table 1, such a result that the user M feels the “depth” in Examples A, B and E, feels the “depth” strongly in Examples C, D, F, and G, and does not feel the “depth” in Comparative Examples A and B has been obtained. Accordingly, it can be found that the “depth” is felt at the edge angle of 5 degrees or more and 75 degrees or less, and the “depth” is strongly felt at the edge angle of 35 degrees or more and 75 degrees or less.

### Examples E1 to E18

The raw materials used in these examples are as shown in the following [Used raw material].

[Used Raw Material]

<Ceramics Base Raw Material>

A-1: 10 parts by mass of china stone, 40 parts by mass of feldspar, 50 parts by mass of clay (70% by mass of SiO2, 25% by mass of Al2O3, and 5% by mass in total of Na2O, K2O, CaO, MgO and ZnO).

A-2: 30 parts by mass of china stone, 70 parts by mass of clay (65% by mass of SiO2, 30% by mass of Al2O3, and 5% by mass in total of Na2O, K2O, CaO, MgO and ZnO).

<Intermediate Layer Raw Material>

B-1: 65% by mass of SiO2, 20% by mass of Al2O3, 12% by mass in total of Na2O, K2O, CaO, MgO and ZnO, and 3% by mass of the others.

B-2: A mixture of the ceramics base raw material A-2 and the following glaze raw material C-9 at a mass ratio (ceramics base/glaze ratio) of 80/20.

B-3: A mixture of the ceramics base raw material A-2 and the following glaze raw material C-9 at a mass ratio (ceramics base/glaze ratio) of 70/30.

B-4: A mixture of the ceramics base raw material A-2 and the following glaze raw material C-9 at a mass ratio (ceramics base/glaze ratio) of 60/40.

B-5: A mixture of the ceramics base raw material A-2 and the following glaze raw material C-9 at a mass ratio (ceramics base/glaze ratio) of 50/50.

B-6: A mixture of the ceramics base raw material A-2 and the following glaze raw material C-9 at a mass ratio (ceramics base/glaze ratio) of 40/60.

B-7: A mixture of the ceramics base raw material A-2 and the following glaze raw material C-9 at a mass ratio (ceramics base/glaze ratio) of 30/70.

B-8: A mixture of the ceramics base raw material A-2 and the following glaze raw material C-9 at a mass ratio (ceramics base/glaze ratio) of 20/80.

B-9: A mixture of the ceramics base raw material A-2 and the following glaze raw material C-9 at a mass ratio (ceramics base/glaze ratio) of 10/90.

B-10: A mixture of the ceramics base raw material A-2 and the following glaze raw material C-9 at a mass ratio (ceramics base/glaze ratio) of 0/100.

<Glaze Raw Material>

C-1: 63% by mass of SiO2, 12% by mass of Al2O3, 24% by mass in total of Na2O, K2O, CaO, MgO, ZnO, SrO, BaO and B2O3, and 1% by mass of the others.

C-2: 62% by mass of SiO2, 13% by mass of Al2O3, 24% by mass in total of Na2O, K2O, CaO, MgO, ZnO, SrO, BaO and B2O3, and 1% by mass of the others.

C-3: 62% by mass of SiO2, 13% by mass of Al2O3, 24% by mass in total of Na2O, K2O, CaO, MgO, ZnO, SrO, BaO and B2O3, and 1% by mass of the others.

C-4: 64% by mass of SiO2, 12% by mass of Al2O3, and 24% by mass in total of Na2O, K2O, CaO, MgO, ZnO, SrO, BaO and B2O3.

C-5: 57% by mass of SiO2, 10% by mass of Al2O3, 32% by mass in total of Na2O, K2O, CaO, MgO, ZnO, SrO, BaO and B2O3, and 1% by mass of the others.

C-6: 63% by mass of SiO2, 12% by mass of Al2O3, 24% by mass in total of Na2O, K2O, CaO, MgO, ZnO, SrO, BaO and B2O3, and 1% by mass of the others.

C-7: 66% by mass of SiO2, 12% by mass of Al2O3, and 22% by mass in total of Na2O, K2O, CaO, MgO, ZnO, SrO, BaO and B2O3.

C-8: 70% by mass of SiO2, 11% by mass of Al2O3, and 19% by mass in total of Na2O, K2O, CaO, MgO, ZnO, SrO, BaO and B2O3.

C-9: 63% by mass of SiO2, 10% by mass of Al2O3, 20% by mass in total of Na2O, K2O, CaO, MgO, ZnO, SrO, BaO and B2O3, and 7% by mass of the others.

C-10: 61% by mass of SiO2, 12% by mass of Al2O3, and 27% by mass in total of Na2O, K2O, CaO, MgO, ZnO, SrO, BaO and B2O3.

C-11: 57% by mass of SiO2, 11% by mass of Al2O3, 25% by mass in total of Na2O, K2O, CaO, MgO, ZnO, SrO, BaO and B2O3, and 7% by mass of the others.

[Preparation of Ceramics Base Material]

1 kg of ceramics base raw material A-1 and 0.4 kg of water were mixed to obtain a mixture. The mixture was grinded by a ball mill for 20 hours to obtain a ceramics base composition. As a result of measuring the particle size of the solid content of the ceramics base material composition using a laser diffraction type particle size distribution measuring device (“MT3300EX (model number)”, manufactured by Nikkiso Co., Ltd.), D50 was 12 μm.

Next, the ceramics base material composition was poured into a plaster mold having a length of 100 mm, a width of 100 mm, and a thickness of 10 mm to obtain a ceramics base material.

[Preparation of Frit]

The glaze raw materials C-1 to C-11 were melted at 1500° C. as frit raw materials to obtain frits F-1 to F-11.

[Preparation of Intermediate Layer Composition]

1 kg of the intermediate layer raw material B-1 and 0.4 kg of water were mixed to obtain a mixture. The mixture was grinded by a ball mill for 20 hours to obtain an intermediate layer composition M-1. As a result of measuring the particle size of the solid content of the intermediate layer composition M-1 using the laser diffraction type particle size distribution measuring device, D50 was 8 μm.

Intermediate layer compositions M-2 to M-10 were obtained in the same manner as the intermediate layer composition M-1 except that the intermediate layer raw materials B-2 to B-10 were used instead of the intermediate layer raw material B-1. The intermediate layer composition M-11 was prepared by mixing 1 kg of the glaze raw material C-11 and 0.6 kg of water as an intermediate layer raw material to obtain a mixture. In Tables 2 and 3, “type” of the intermediate layer composition represents any of the intermediate layer compositions M-1 to M-11. The “D50 (μm)” of the intermediate layer composition represents the 50% average particle size (D50) of any of the above intermediate layer compositions M-1 to M-11.

[Preparation of Upper Glaze Layer Composition]

1 kg of frit F-1 and 0.6 kg of water were mixed to obtain a mixture. The mixture was grinded by a ball mill for 30 hours, and a viscosity modifier such as carboxymethyl cellulose was added to adjust viscosity, whereby an upper glaze layer composition G-1 was obtained. As a result of measuring the particle size of the solid content of the upper glaze layer composition G-1 using the above-mentioned laser diffraction type particle size distribution measuring device, D50 was 15 μm.

The upper glaze layer compositions G-2 to G-10 were obtained by the same method as the upper glaze layer composition G-1 except that the frits F-2 to F-10 were used instead of the frit F-1. In Tables 2 and 3, the “type” of the upper glaze layer composition represents any of the above-mentioned upper glaze layer compositions G-1 to G-10. The “D50 (μm)” of the upper glaze layer composition represents the 50% average particle size (D50) of any of the above upper glaze layer compositions G-1 to G-10.

### Examples E1 to E18 and Comparative Examples CE1 to CE2

[Preparation of Sanitary Ware]

The intermediate layer compositions described in Tables 2 and 3 were applied to the above-mentioned ceramics base material using a spray coating method, dried at 60° C. for 1 hour, and then spray coated with the upper glaze layer compositions described in Tables 2-3, whereby secondary coated bodies were obtained. The secondary coated bodies were fired at 1220° C. for 20 hours to obtain rectangular solid samples of the sanitary ware.

<Measurement of Thickness of Upper Glaze Layer>

The sample of each example was cut using a small sample cutter in the thickness direction along a plane which passes through a midpoint of one side of the sample in a longitudinal direction thereof and is parallel to a width direction of the sample. The cut surface after cutting was observed with a microscope (DSX510, manufactured by Olympus Corporation) at a magnification of 125 times. The observed image was equally divided into 10 parts in the width direction, and the distance from the surface of the upper glaze layer to the upper-intermediate boundary line (L30) was measured at 2 places for each sample. Distances (L30) in total of 20 places were measured for one sample, and the maximum value of the thickness of the upper glaze layer, the minimum value of the thickness of the upper glaze layer, the difference between the maximum value and the minimum value, and the average value were determined. An average value of the distances (L30) was determined as the thickness of the upper glaze layer. The results are shown in Tables 2 and 3. In the tables, the “difference” represents the difference between the maximum value and the minimum value of the thickness of the upper glaze layer.

<Measurement of Thickness of Intermediate Layer>

Using the image observed with the thickness of the upper glaze layer, the observed image was equally divided into 10 parts in the width direction, and the distance between the upper-intermediate boundary line and the intermediate-ceramics base material boundary line (L20) was measured at 2 places for each sample. Distances (L20) in total of 20 places were measured for one sample, and the average value was determined as the thickness of the intermediate layer. The results are shown in Tables 2 and 3.

<Measurement of Average Pore Size, Pore Area Ratio, Number of Pores>

Using the image observed with the above microscope, the image was binarized with device processing software (WinROOF2015, provided by Mitani Shoji Co., Ltd.), and the average pore size, the pore area ratio, and the number of pores in the cut surface of the upper glaze layer were determined through image analysis. In addition, the average pore size, the pore area ratio, and the number of pores in the cut surface of the intermediate layer were determined. The results are shown in Tables 2 and 3.

<Measurement of Image Clarity>

The sample of each example was prepared, and the DOI value was measured by a Wave-Scan DOI measuring device (Wave-Scan-DUAL, manufactured by BYK Gardner). The results are shown in Tables 2 and 3.

<Evaluation of “Depth”>

The sample of each example were prepared, held up to a fluorescent light in a room, and subjected to appearance sensitivity evaluation from the viewpoint of feeling the deepness of light as the “depth” and feeling of the surface cleanness. The appearance sensitivity evaluation was conducted by 10 subjects, and the “depth” was evaluated based on the following evaluation criteria. The results are shown in Tables 2 and 3.

“Evaluation Criteria”

OK: The number of subjects who feel the “depth” is 5 or more.

NG: The number of subjects who feel the “depth” is 4 or less.

TABLE 2

| | | | | EXAMPLE NUMBER | | | | | |
|---|---|---|---|---|---|---|---|---|---|
| | | | | E1 | E2 | E3 | E4 | E5 | E6 |
| STRUCTURE | UPPER | UPPER GLAZE | TYPE | G-1 | G-2 | G-3 | G-4 | G-5 | G-6 |
| OF | GLAZE LAYER | LAYER | D50 (μm) | 15 | 15 | 15 | 15 | 15 | 15 |
| LAYERS | | COMPOSITION | | | | | | | |
| | | THICKNESS | MAXIMUM | 295 | 275 | 325 | 278 | 360 | 303 |
| | | (μm) | VALUE | | | | | | |
| | | | MINIMUM | 265 | 227 | 278 | 240 | 333 | 286 |
| | | | VALUE | | | | | | |
| | | | DIFFERENCE | 30 | 48 | 47 | 38 | 28 | 17 |
| | | | AVERAGE | 282 | 253 | 309 | 269 | 349 | 295 |
| | | | VALUE | | | | | | |
| | | AVERAGE PORE SIZE (μm) | | 13 | 14 | 14 | 23 | 24 | 17 |
| | | PORE AREA RATIO (%) | | 0.43 | 0.95 | 1.53 | 1.32 | 1.38 | 1.26 |
| | | NUMBER OF PORES/mm² | | 26 | 41 | 48 | 27 | 16 | 40 |
| | INTERMEDIATE | INTERMEDIATE | TYPE | M-1 | M-1 | M-1 | M-1 | M-1 | M-1 |
| | LAYER | LAYER | D50 (μm) | 8 | 8 | 8 | 8 | 8 | 8 |
| | | COMPOSITION | | | | | | | |
| | | THICKNESS (μm) | AVERAGE | 512 | 558 | 583 | 508 | 554 | 555 |
| | | | VALUE | | | | | | |

| | | | | | | |
|---|---|---|---|---|---|---|
| AVERAGE PORE SIZE (μm) | 14 | 14 | 13 | 13 | 14 | 13 |
| PORE AREA RATIO (%) | 10.7 | 10.5 | 8.69 | 9.1 | 8.74 | 9.75 |
| NUMBER OF PORES/mm² | 440 | 419 | 398 | 443 | 349 | 415 |

| | | | | | | | |
|---|---|---|---|---|---|---|---|
| EVALUATION | DEPTH | OK | OK | OK | OK | OK | OK |
| | IMAGE CLARITY | 92 | 91 | 91 | 94 | 93 | 94 |

| | | | | EXAMPLE NUMBER | | | | |
|---|---|---|---|---|---|---|---|---|
| | | | | E7 | E8 | E9 | E10 | E11 |
| STRUCTURE | UPPER | UPPER GLAZE | TYPE | G-7 | G-8 | G-9 | G-4 | G-4 |
| OF | GLAZE LAYER | LAYER | D50 (μm) | 15 | 15 | 15 | 15 | 15 |
| LAYERS | | COMPOSITION | | | | | | |
| | | THICKNESS | MAXIMUM | 328 | 324 | 327 | 225 | 252 |
| | | (μm) | VALUE | | | | | |
| | | | MINIMUM | 299 | 296 | 299 | 170 | 232 |
| | | | VALUE | | | | | |
| | | | DIFFERENCE | 29 | 28 | 28 | 55 | 19 |
| | | | AVERAGE | 319 | 318 | 311 | 208 | 243 |
| | | | VALUE | | | | | |

| | AVERAGE PORE SIZE (μm) | | 15 | 13 | 12 | 15 | 20 |
|---|---|---|---|---|---|---|---|
| | PORE AREA RATIO (%) | | 1.31 | 1.34 | 1.32 | 2.3 | 2.11 |
| | NUMBER OF PORES/mm² | | 51 | 59 | 69 | 70 | 47 |
| INTERMEDIATE | INTERMEDIATE | TYPE | M-1 | M-1 | M-1 | M-2 | M-3 |
| LAYER | LAYER | D50 (μm) | 8 | 8 | 8 | 9 | 9 |
| | COMPOSITION | | | | | | |
| | THICKNESS (μm) | AVERAGE | 497 | 511 | 523 | 458 | 504 |
| | | VALUE | | | | | |

| | | | | | |
|---|---|---|---|---|---|
| AVERAGE PORE SIZE (μm) | 14 | 13 | 14 | 8 | 12 |
| PORE AREA RATIO (%) | 9.18 | 9.34 | 9.74 | 7.56 | 9.46 |
| NUMBER OF PORES/mm² | 417 | 432 | 398 | 613 | 535 |

| | | | | | | |
|---|---|---|---|---|---|---|
| EVALUATION | DEPTH | OK | OK | OK | OK | OK |
| | IMAGE CLARITY | 85 | 85 | 77 | 80 | 85 |

TABLE 3

| | | | | EXAMPLE NUMBER | | | | |
|---|---|---|---|---|---|---|---|---|
| | | | | E12 | E13 | E14 | E15 | E16 |
| STRUCTURE | UPPER | UPPER GLAZE | TYPE | G-4 | G-4 | G-4 | G-4 | G-4 |
| OF | GLAZE LAYER | LAYER | D50 (μm) | 15 | 15 | 15 | 15 | 15 |
| LAYERS | | COMPOSITION | | | | | | |
| | | THICKNESS | MAXIMUM VALUE | 253 | 231 | 199 | 221 | 244 |
| | | (μm) | MINIMUM VALUE | 227 | 197 | 159 | 172 | 166 |
| | | | DIFFERENCE | 26 | 34 | 40 | 48 | 79 |
| | | | AVERAGE VALUE | 242 | 221 | 181 | 214 | 218 |
| | | AVERAGE PORE SIZE (μm) | | 9 | 16 | 19 | 12 | 17 |
| | | PORE AREA RATIO (%) | | 0.7 | 2.82 | 1.15 | 2.31 | 1.41 |
| | | NUMBER OF PORES/mm² | | 67 | 103 | 30 | 93 | 40 |
| | INTERMEDIATE | INTERMEDIATE | TYPE | M-4 | M-5 | M-6 | M-7 | M-8 |
| | LAYER | LAYER | D50 (μm) | 8 | 8 | 8 | 7 | 7 |
| | | COMPOSITION | | | | | | |
| | | THICKNESS (μm) | AVERAGE VALUE | 575 | 696 | 494 | 505 | 566 |

| | | | | | |
|---|---|---|---|---|---|
| AVERAGE PORE SIZE (μm) | 13 | 16 | 19 | 27 | 20 |
| PORE AREA RATIO (%) | 10.9 | 11.2 | 9.76 | 14.4 | 12.1 |
| NUMBER OF PORES/mm² | 430 | 269 | 189 | 135 | 149 |

| | | | | | | |
|---|---|---|---|---|---|---|
| EVALUATION | DEPTH | OK | OK | OK | OK | OK |
| | IMAGE CLARITY | 93 | 89 | 87 | 82 | 80 |

| | | | | EXAMPLE NUMBER | | | |
|---|---|---|---|---|---|---|---|
| | | | | E17 | E18 | CE1 | CE2 |
| STRUCTURE | UPPER | UPPER GLAZE | TYPE | G-4 | G-4 | G-10 | G-10 |
| OF | GLAZE LAYER | LAYER | D50 (μm) | 15 | 15 | 15 | 15 |
| LAYERS | | COMPOSITION | | | | | |
| | | THICKNESS | MAXIMUM VALUE | 265 | 245 | 604 | 1085 |
| | | (μm) | MINIMUM VALUE | 187 | 186 | 528 | 0 |
| | | | DIFFERENCE | 77 | 59 | 76 | 1085 |
| | | | AVERAGE VALUE | 222 | 225 | 572 | 862 |

| | AVERAGE PORE SIZE (μm) | | 14 | 8 | 68 | 60 |
|---|---|---|---|---|---|---|
| | PORE AREA RATIO (%) | | 0.71 | 0.71 | 3.29 | 3.5 |
| | NUMBER OF PORES/mm² | | 35 | 74 | 3 | 10 |
| INTERMEDIATE | INTERMEDIATE | TYPE | M-9 | M-10 | M-1 | M-11 |
| LAYER | LAYER | D50 (μm) | 6 | 6 | 8 | 15 |
| | COMPOSITION | | | | | |
| | THICKNESS (μm) | AVERAGE VALUE | 551 | 456 | 576 | 782 |

| | | | | |
|---|---|---|---|---|
| AVERAGE PORE SIZE (μm) | 28 | 25 | 14 | 70 |
| PORE AREA RATIO (%) | 11.4 | 6.7 | 7.99 | 6 |
| NUMBER OF PORES/mm² | 100 | 65 | 298 | 20 |

| | | | | | |
|---|---|---|---|---|---|
| EVALUATION | DEPTH | OK | OK | NG | NG |
| | IMAGE CLARITY | 91 | 91 | 70 | 70 |

As shown in Tables 2 and 3, in Examples E1 to E18, the evaluation of the “depth” was “OK”, and it was found that the “depth” had been further improved. On the other hand, in Comparative Examples CE1 and CE2 in which any of the average pore size, the pore area ratio, and the number of pores in the cut surface of the upper glaze layer is out of the applicable range of the disclosure, the evaluation of the “depth” was “NG”.

The average pore sizes of the upper glaze layer in each Example were 24 μm or less and good evaluations were obtained. The pore area ratios of the upper glaze layer in each Example were 2.82% or less, accordingly, the values were able to be suppressed. The average thicknesses of the upper glaze layer in each Example were 360 μm or less and good evaluations were obtained. The number of pores of the upper glaze layer in each Example were 16 per mm2, and good evaluations were obtained.

It should be understood that all shapes, combinations, and the like of the constituent members shown in the above-described embodiments are merely examples, and various changes can be made based on design requirements and the like without departing from the spirit of the disclosure.

For example, in the embodiments described above, the curved surface 101u of the bowl portion 101 is formed into a curved surface except for the bottom portion 101b, but the disclosure is not limited thereto. At least a side facing the user of the surface of the bowl recessed downward may be formed of a continuous curved surface.

1. A washbowl comprising:
a bowl recessed downward, comprising a ceramics base material, an intermediate layer disposed on a surface side of the ceramics base, and an upper glaze layer disposed on a surface side of the intermediate layer, the upper glaze layer being more transparent than the intermediate layer; and
a drainage port,
wherein the bowl includes an inclined surface formed on a surface of the bowl and continuously recessed downward, the inclined surface formed at a position at least on a front side of the surface of the bowl when a user uses the bowl, the position being configured to be seen by the user, and
wherein the inclined surface is formed such that a tangent to the inclined surface is 5 degrees to 75 degrees with respect to a horizontal plane.

2. The washbowl of claim 1, wherein an end portion on the front side of the continuous inclined surface constitutes a circumferential edge portion of the bowl.

3. The washbowl of claim 1, wherein the continuous inclined surface is formed such that a tangent to the end portion on the front side of the continuous inclined surface is 35 degrees or more with respect to the horizontal plane.

4. The washbowl of claim 1, wherein the continuous inclined surface is formed such that a tangent to the end portion on the front side of the continuous inclined surface is 45 degrees or less with respect to the horizontal plane.

5. The washbowl of claim 1, wherein an average pore diameter of the upper glaze layer is 24 μm or less.

6. The washbowl of claim 1, wherein a pore area ratio of the upper glaze layer is 2.82% or less.

7. The washbowl of claim 1, wherein a number of pores of the upper glaze layer is 16 per mm² or more.

8. The washbowl of claim 1, wherein a thickness of the upper glaze layer is 360 μm or less.
